(19) United States
(12) Patent Application Publication
(10) Pub. No.: US 2025/0193622 A1
(43) Pub. Date: Jun. 12, 2025

(54) ACOUSTIC SIGNAL CONTROL METHOD, LEARNING MODEL GENERATION METHOD, AND ACOUSTIC SIGNAL CONTROL PROGRAM PRODUCT

(71) Applicant: Sony Group Corporation, Tokyo (JP)

(72) Inventors: Atsushi Yamamoto, Tokyo (JP); Yuji Nakanishi, Tokyo (JP); Natsuko Maeda, Kanagawa (JP); Naoki Shinmen, Tokyo (JP); Koya Sato, Kanagawa (JP); Yuta Sato, Kanagawa (JP); Kazuki Sakai, Tokyo (JP)

(73) Assignee: Sony Group Corporation, Tokyo (JP)

(21) Appl. No.: 18/846,369

(22) PCT Filed: Mar. 13, 2023
(86) PCT No.: PCT/JP2023/009489

§ 371 Date: Sep. 12, 2024

(30) Foreign Application Priority Data
Mar. 25, 2022 (JP) 2022-050038

(51) Int. Cl. H04S 7/00; G06F 3/04815; G06F 3/04845

(52) U.S. Cl. CPC H04S 7/302; G06F 3/04815; G06F 3/04845; H04S 2400/11

(57) ABSTRACT

An acoustic signal control method includes: selecting a sound source object to be arranged on a three-dimensional virtual space, arranging the selected sound source object at a predetermined position on the three-dimensional virtual space in which one or more three-dimensional objects are arranged; inputting position data and acoustic data regarding the arranged sound source object, region data in the three-dimensional virtual space, structure data of the three-dimensional object, and position data of each object and a sound reception point at a predetermined time to first artificial intelligence, and outputting, on the basis of an impulse response at the sound reception point generated from output data, an acoustic signal at the sound reception point, by a computer.

### FIELD

The present disclosure relates to an acoustic signal control method, a learning model generation method, and an acoustic signal control program product.

### BACKGROUND

As virtual space technologies such as meta-verse and games develop, realistic experience based on reality is required also for sound reproduced on a virtual space. Currently, examples of a method used for such acoustic processing include, for example, a sound ray tracking method for geometrically analyzing from a transmission point to a reception point of sound. However, in the sound ray tracking method, since a wave component of the sound is excluded, it is impossible in principle to implement diffraction and portaling (an acoustic effect at a boundary between spaces in consideration of a door and the like present in the virtual space) caused by the wave.

In contrast, according to the acoustic processing using a wave equation, it is possible to reproduce a phenomenon caused by the wave. However, the acoustic processing using the wave equation has a significantly large calculation load as compared with the sound ray tracking method, and it is difficult to perform acoustic operation following a player's line of sight in the game. In this regard, a method is known in which an acoustic space is divided into regions in order to calculate wave sound, and acoustic processing is performed between the divided boundaries to increase an arithmetic speed (for example, Non-Patent Literature 1 below). A deep learning method for deriving an expression for performing an operation satisfying physical rules using machine learning has also been proposed (for example, Non-Patent Literature 2 below).

### CITATION LIST

### Non Patent Literature

Non Patent Literature 1: “Efficient and Accurate Sound Propagation Using Adaptive Rectangular Decomposition” N. Raghuvanshi et al., IEEE(2009)
Non Patent Literature 2: “Physics-informed neural networks: A deep learning framework for solving forward and inverse problems involving nonlinear partial differential equations” M. Raissi, P. Perdikaris, G. E. Karniadakis, Journal of Computational Physics 378(2019)

### SUMMARY

### Technical Problem

According to Non-Patent Literature 1, it is possible to implement an arithmetic speed that can withstand use in a game and the like by dividing a space and relaxing a calculation load.

However, in the technology disclosed in Non-Patent Literature 1, since a change with discontinuity might occur in the parameter related to the acoustic processing at the boundary between the spaces, the real physics cannot be reproduced, and unnatural sound might be reproduced in terms of audibility. In the technology disclosed in Non-Patent Literature 1, a diffraction and the like in a case where there is a structure on a boundary surface might be unnaturally reproduced.

Therefore, the present disclosure proposes an acoustic signal control method, a learning model generation method, and an acoustic signal control program product capable of reproducing an acoustic space with realistic feeling and implementing high-speed arithmetic processing.

### Solution to Problem

An acoustic signal control method according to one embodiment of the present disclosure includes: selecting a sound source object to be arranged on a three-dimensional virtual space, arranging the selected sound source object at a predetermined position on the three-dimensional virtual space in which one or more three-dimensional objects are arranged; inputting position data and acoustic data regarding the arranged sound source object, region data in the three-dimensional virtual space, structure data of the three-dimensional object, and position data of each object and a sound reception point at a predetermined time to first artificial intelligence, and outputting, on the basis of an impulse response at the sound reception point generated from output data, an acoustic signal at the sound reception point, by a computer.

### BRIEF DESCRIPTION OF DRAWINGS

FIG. 1 is a view illustrating an outline of information processing according to a first embodiment.

FIG. 2 is a view illustrating a configuration example of a sound production device according to the first embodiment.

FIG. 3 is a view (1) for describing learning processing according to the first embodiment.

FIG. 4 is a view (2) for describing learning processing according to the first embodiment.

FIG. 5 is a view for describing arithmetic processing according to the first embodiment.

FIG. 6 is a flowchart illustrating a procedure of the learning processing according to the first embodiment.

FIG. 7 is a flowchart illustrating a procedure of the arithmetic processing according to the first embodiment.

FIG. 8 is a view illustrating another example of the arithmetic processing according to the first embodiment.

FIG. 9 is a view illustrating an outline of information processing according to a second embodiment.

FIG. 10 is a flowchart illustrating a procedure of the information processing according to the second embodiment.

FIG. 11 is a view (1) illustrating an example of a user interface provided by a sound production device.

FIG. 12 is a view (1) illustrating an operation example in the user interface.

FIG. 13 is a view (2) illustrating an operation example in the user interface.

FIG. 14 is a view (3) illustrating an operation example in the user interface.

FIG. 15 is a view (4) illustrating an operation example in the user interface.

FIG. 16 is a view (5) illustrating an operation example in the user interface.

FIG. 17 is a view (6) illustrating an operation example in the user interface.

FIG. 18 is a view (1) illustrating an example of learning processing according to a third embodiment.

FIG. 19 is a view (2) illustrating an example of the learning processing according to the third embodiment.

FIG. 20 is a flowchart illustrating a procedure of arithmetic processing according to the third embodiment.

FIG. 21 is a hardware configuration diagram illustrating an example of a computer that implements a function of the sound production device.

### DESCRIPTION OF EMBODIMENTS

Hereinafter, embodiments of the present disclosure are described in detail with reference to the drawings. Note that, in each of the following embodiments, the same parts are denoted by the same reference signs, and redundant description is omitted.

The present disclosure is described according to the following order of items.
1. First Embodiment
1-1. Outline of Information Processing according to First Embodiment
1-2. Configuration of Sound Production Device according to First Embodiment
1-3. Procedure of Information Processing according to First Embodiment
1-4. Execution Example of Information Processing according to First Embodiment
2. Second Embodiment
2-1. Outline of Information Processing according to Second Embodiment
2-2. Procedure of Information Processing according to Second Embodiment
3. Third Embodiment
4. Fourth Embodiment
5. Fifth Embodiment
6. Sixth Embodiment
7. Seventh Embodiment
8. Eighth Embodiment
9. Other Embodiment
10. Effect of Acoustic Signal Control Method and Learning Model Generation Method according to Present Disclosure
11. Hardware Configuration

### 1. First Embodiment

### 1-1. Outline of Information Processing According to First Embodiment

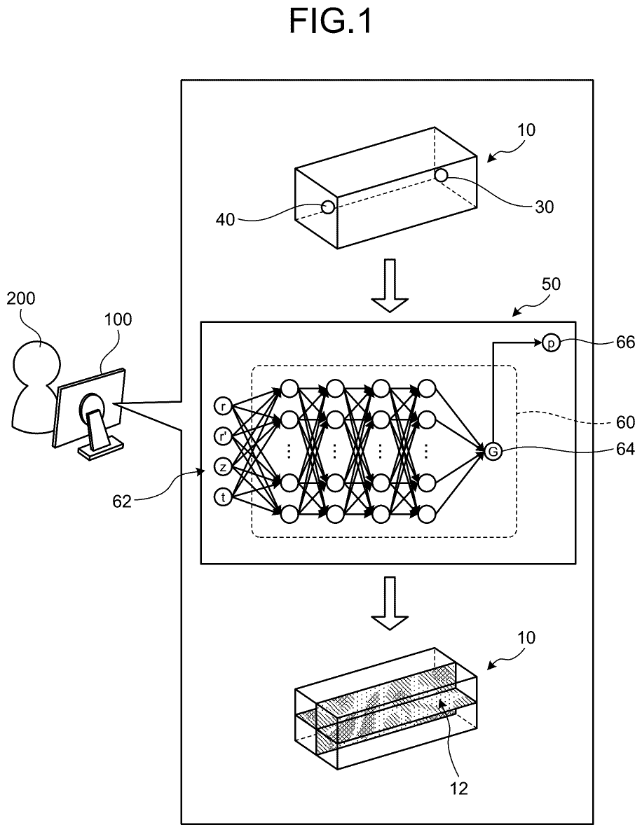

First, an outline of information processing according to a first embodiment is described with reference to FIG. 1. FIG. 1 is a view illustrating the outline of the information processing according to the first embodiment.

The information processing according to the first embodiment (an acoustic signal control method and the like according to the present disclosure) is executed by a sound production device 100 illustrated in FIG. 1. The sound production device 100 is an example of an acoustic signal control device (information processing terminal) according to the present disclosure, and is an information processing terminal used by a producer 200 who produces a content related to a virtual space such as games and meta-verse. For example, the sound production device 100 is a personal computer (PC), a server device, a tablet terminal and the like.

The sound production device 100 includes an output unit such as a display and a speaker, and outputs various types of information (or data) to the producer 200. For example, the sound production device 100 displays a user interface of software related to sound production on the display. The sound production device 100 outputs a generated acoustic signal from the speaker according to an operation by an instruction by the producer 200 on the user interface.

In the first embodiment, the sound production device 100 calculates, in a virtual three-dimensional space (hereinafter, simply referred to as the “virtual space”) of the game and the like, as what type of sound the sound output from a sound source object, which is a sound production point of the sound, is reproduced at a sound reception point, and reproduces the calculated sound. That is, the sound production device 100 performs acoustic simulation in the virtual space, and performs processing of bringing the sound emitted on the virtual space close to that of the real world or reproducing sound desired by the producer 200.

FIG. 1 illustrates a virtual space 10 on the game for which the producer 200 intends to design the sound. For example, the virtual space 10 is displayed on the display included in the sound production device 100. The producer 200 sets a position (coordinates) of the sound source object (sound production point of the sound) and sets the sound reception point (position at which the sound is listened to in the virtual space 10) in the virtual space 10. In an example in FIG. 1, the producer 200 sets the sound source object as a sound production point 30, and sets a location position of a character and the like on the game as a sound reception point 40, for example, in the virtual space 10. The sound reception point 40 is a position at which the sound output from the sound production point 30 is observed, and is, for example, a position at which a game character operated by a player is located (more specifically, position coordinates corresponding to a head of the game character).

One or more three-dimensional objects (hereinafter, simply referred to as “objects”) are arranged in the virtual space 10. Although not illustrated in FIG. 1, for example, a furniture-shaped object, a human-shaped object and the like may be arranged in the virtual space 10. In the virtual space 10, a wall, the ceiling and the like serving as boundaries forming the virtual space 10 are also arranged. Note that, in the following description, the boundaries such as the wall and ceiling might also be handled as one of objects arranged in the virtual space 10.

In a real space, a difference occurs between the sound observed in the vicinity of the sound source and the sound observed at the sound reception point due to various physical phenomena. Therefore, the sound production device 100 virtually reproduces (simulates) real physical phenomena in the virtual space 10 according to the instruction of the producer 200, and generates the acoustic signal suitable for the space so as to enhance a realistic feeling of sound expression experienced in the virtual space 10 by the game player and the like (hereinafter referred to as a “player”) who uses the content.

Here, the acoustic signal generated by the sound production device 100 is described. The acoustic signal generated in the virtual space 10 is determined on the basis of factors such as an indoor environment (parameters such as a volume of the space and a sound absorption coefficient of a wall surface) set in the virtual space 10, a distance between the sound production point 30 and the sound reception point 40, and a shape of the space (presence or absence of an obstacle). Examples of a method of reproducing such acoustic signal include geometric simulation such as a sound ray method and wave acoustic simulation in which a wave phenomenon, which is a sound propagation state, is reproduced using a wave equation.

Among them, in a sound ray tracking method, since a wave component of the sound is excluded, it is impossible in principle to implement diffraction and portaling caused by the wave. In contrast, according to the acoustic processing using a wave equation, it is possible to reproduce a phenomenon caused by the wave. However, the acoustic processing using the wave equation has a significantly large calculation load as compared with the sound ray tracking method, and it is difficult to perform acoustic operation following a player's line of sight in the game. Even if a method of dividing the space to increase a calculation speed is adopted, since a change in stepwise function might occur in the parameter related to the acoustic processing at the boundary between the spaces, the real physics cannot be reproduced, and an unnatural sound might be reproduced in terms of audibility. Such method might result in unnatural reproduction even in diffraction and the like in a case where there is a structure on a boundary surface. That is, in order to implement high-speed processing while reproducing sound without a strange feeling for the producer 200 and the player in the virtual space 10, it is an issue to calculate a wave sound at high speed without the strange feeling.

As an example of such physical arithmetic method, a finite difference time domain method (FDTD method) is proposed. In the FDTD method, a sound field to be processed is spatially and temporally discretized, a differential term of a dominant equation (wave equation) is expanded into a difference equation, and calculation is sequentially performed to obtain a solution. As one method, calculation is performed using a staggered grid that provides a sound pressure and a particle speed in a half-integer coordinate system. In order to solve them, it is necessary to discretize an entire space by coordinates to perform the calculation, so that, from the viewpoint of real-time operation, a significantly high computer capability is required. At that time, it is conceivable to reduce an operation amount by reducing a frequency band, but since a frequency of an initial reflected sound significantly depends on the sound source, there is a possibility that reproducibility cannot be improved.

As a method for solving such problem, the sound production device 100 executes the acoustic signal control method according to the embodiment. Specifically, the sound production device 100 uses a method (also referred to as physics informed neural networks (PINNs) of satisfying physical rules in machine learning and performing deep learning. As a result, the sound production device 100 can calculate the wave component of the sound at high speed without solving the wave equation for the entire space. According to the acoustic signal control method according to the embodiment, since there is no restriction such as division of a space size of the sound field, it is not necessary to divide the virtual space 10 into fine boundaries. Moreover, since the acoustic signal control method according to the embodiment solves a physical expression applied to the deep learning with a transfer function as a target, it is also possible to calculate a situation in which the sound production point 30 and the sound reception point 40 move and an influence of movement of another object and the like in the virtual space 10. That is, in the acoustic signal control method according to the embodiment, it is possible to output the wave sound in real time at the time of operation by pre-learning of the transfer function including the influence of the movement and the like, so that it is possible to provide the player with a real acoustic experience.

Hereinafter, an outline of processing in which the sound production device 100 executes the acoustic signal control method according to the embodiment is described with reference to FIG. 1.

First, the producer 200 sets the virtual space 10, and the sound production point 30 and the sound reception point 40 in the virtual space 10 in the user interface provided by the sound production device 100. For example, the producer 200 selects any sound source object in which intensity, tone and the like of the sound are set on the user interface, and arranges the same in the virtual space 10 as the sound production point 30.

The sound production device 100 executes learning processing of a model 60 included in a learning configuration 50 on the basis of a condition provided by the producer 200. The model 60 is predetermined artificial intelligence, and is implemented as a deep neural network (DNN) or any machine learning algorithm. For example, the model 60 is the DNN for implementing the above-described PINNs.

The model 60 is generated by the learning processing so as to receive an input of various data (data set) as training data and output a Green's function 64, which is the transfer function between the sound source and the sound reception. Here, in the first embodiment, the Green's function 64 is used for calculating an impulse response and a sound pressure at the sound reception point 40 using predetermined function conversion. That is, the model 60 is an artificial intelligence model generated to receive various data as the input and output the Green's function 64 as the output. Although the learning is to be described later in detail, the model 60 performs the learning processing of the model 60 so as to output the parameter of the Green's function 64 by a method of minimizing an error between a value output from the model 60 and the training data that presents the output value, using, for example, an actual measurement value and the like simulated using the FDTD method and the like in a learning environment (the virtual space 10 in the example of FIG. 1) as the training data. Note that, the Green's function 64 itself defines a shape of a function curve of the impulse response on the basis of a predetermined input. That is, in the model 60, for example, a Green's function curve can be generated by complementing the curve by using outputs of n nodes arranged in a layer immediately before a node G, which is the Green's function, in FIG. 1 as n sample points in a time axis direction of the impulse response. At that time, the sound production device 100 can perform the learning by minimizing an error between a curve shape of the training model and each sample point.

Input information 62 to the model 60 is a data set used as the training data of the model 60 (teacher data for the input and output of the model 60). Out of the input information 62, the input data of the model 60 may include, for example, coordinate data of a structure forming the virtual space 10, coordinate data of the sound reception point 40 (corresponding to “r” illustrated in FIG. 1), the sound production point 30 (corresponding to “r′” illustrated in FIG. 1), and a boundary condition (corresponding to “z” illustrated in FIG. 1) such as the acoustic impedance of the structure and object forming the virtual space 10. Since the output of the Green's function 64 formed in the output layer of the model 60 generated by the learning processing obtains the impulse response of the sound reception point 40 at “any time”, the input data of the model 60 out of the input information 62 also includes a parameter indicating time (corresponding to “t” in FIG. 1).

For example, the sound production device 100 generates learning data by variously changing conditions such as the acoustic impedance, the positions of the sound production point 30 and the sound reception point 40, and a size of the sound source on the basis of the structure of the virtual space 10 given from the producer 200, and performs learning of the model 60 on the basis of the generated learning data. As a result, the sound production device 100 generates the model 60 capable of outputting the impulse response of the Green's function 64 suitable for the virtual space 10 by the learning processing. Note that, since the Green's function 64 formed in the output layer of the model 60 can derive the impulse response and the sound pressure using predetermined function conversion, for example, the sound pressure 66 at the sound reception point 40 can be obtained using the trained model 60. As a result, the sound production device 100 can reproduce the sound in a case where the sound transmitted from the sound production point 30 is listened to at the sound reception point 40 with high accuracy.

Note that, as described above, the data set used as the input of the model 60 includes the coordinate data and time data of the sound reception point and the sound production point as parameters. The model 60 includes, for example, the DNN, and specifically is trained in such a manner that the output of the Green's function 64 formed in a final output layer of the DNN forms an impulse response curve. Moreover, the sound pressure can be calculated by function conversion on the basis of the Green's function output of the model 60. Therefore, the sound production device 100 can indicate sound emitted by a certain sound production point 30 as a distribution on the space. A distribution 12 illustrated in FIG. 1 visually expresses a sound pressure distribution derived by the sound production device 100. For example, in the distribution 12, a dark color portion indicates a high sound pressure, and a light color portion indicates a low sound pressure. Since the input of the model 60 includes time as the parameter, the sound production device 100 can change the distribution 12 in time series. That is, the sound production device 100 can also express propagation of the sound transmitted from the sound production point 30 in time series. In such embodiment, the model 60 learns a relationship of a combination of “r”, “r′”, “t”, and “z” illustrated in FIG. 1. Note that, the Green's function basically includes “r”, “r′”, and “t” as the parameters, but since the sound production device 100 can set the acoustic impedance z, which is the parameter exemplified in FIG. 1, and other boundary conditions (for example, the shape of the object and the like) as input parameters, there is an effect that the Green's function including many parameters of which algorithm has been conventionally difficult to design can be automatically generated by the learning.

As described above, the sound production device 100 according to the first embodiment selects the sound source object to be arranged on the virtual space 10 on the basis of the operation of the producer 200, and arranges the sound source object at a predetermined position on the virtual space 10 as the sound production point 30. Subsequently, the sound production device 100 inputs position data and acoustic data related to the sound production point 30, region data in the virtual space 10, structure data of the object, and position data of each object, the sound reception point, and the sound production point at a predetermined time (they are collectively referred to as the coordinate data and the boundary condition) to the model 60. Note that, the acoustic data is various setting data as the sound such as intensity and tone of the sound set in the sound source object. The region data in the virtual space 10 is, for example, the boundary condition of the virtual space 10 to be analyzed, the coordinate data of the boundary forming the virtual space and the like. The structure data includes the acoustic impedance set in the object, the coordinate data of a point group forming the object and the like.

The sound production device 100 generates the impulse response of the sound reception point 40 as the output of the Green's function 64 forming a part of the model 60. The sound production device 100 outputs the acoustic signal at the sound reception point 40 on the basis of the impulse response of the sound reception point 40 generated from the data output from the model 60. That is, the sound production device 100 calculates the acoustic signal at the sound reception point 40 of the virtual space 10 according to the condition selected by the producer 200 on the user interface, and reproduces the acoustic signal based on the arithmetic result from the speaker and the like. At that time, the sound production device 100 outputs the acoustic signal on the basis of the sound pressure at the sound reception point calculated from the impulse response at the sound reception point.

In this manner, the sound production device 100 can obtain simulation of the acoustic signal in the virtual space 10 using the trained artificial intelligence (model 60), thereby reproducing the acoustic signal with high accuracy without performing enormous calculation processing. Although it is described later in detail, according to the sound production device 100, the simulation is performed using the model 60 including the boundary condition such as the coordinate data and time as the parameters, it is possible to provide acoustic simulation according to a space design desired by the producer 200 in real time by, for example, changing the structure in the space and immediately calculating the wave component according to the change.

### 1-2. Configuration of Sound Production Device According to First Embodiment

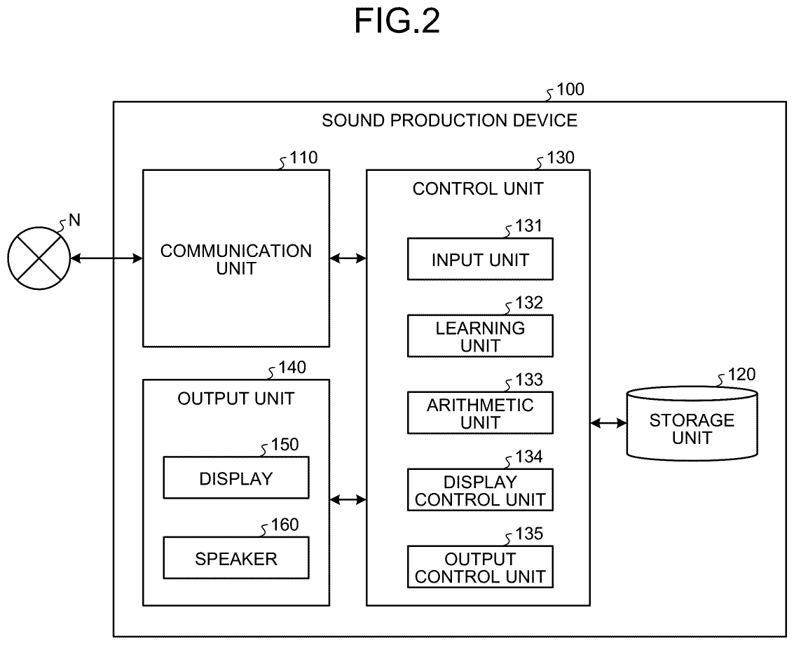

Next, a configuration of the sound production device 100 according to the first embodiment is described with reference to FIG. 2. FIG. 2 is a view illustrating a configuration example of the sound production device 100 according to the first embodiment.

As illustrated in FIG. 2, the sound production device 100 includes a communication unit 110, a storage unit 120, a control unit 130, and an output unit 140. Note that, the sound production device 100 may include an input means (for example, a touch panel, a keyboard, a pointing device such as a mouse, a voice input microphone, an image input camera (line of sight, gesture input)) and the like that acquires various operation inputs from the producer 200 and the like who operates the sound production device 100.

The communication unit 110 is implemented by, for example, a network interface card (NIC) and the like. The communication unit 110 is connected to a network N (cloud, Internet, local area network, near field communication (NFC), Bluetooth (registered trademark) and the like) in a wired or wireless manner, and transmits and receives information (data) to and from other information devices and the like via the network N.

The storage unit 120 is implemented by, for example, a semiconductor memory element such as a random access memory (RAM) and a flash memory, or a storage device such as a hard disk and an optical disk. The storage unit 120 stores various data such as, for example, voice data output from the sound production point 30, shape data of the object, and a preset set value of a sound absorption coefficient for each object. The storage unit 120 stores a “pre-learning model (for learning)” and a “post-learning model (for execution)” for the model 60 generated in the learning processing to be described later. In the learning processing, a current “learning model for execution” may be copied in the storage area of the “model for learning”, the model generated as a result of the learning processing may be copied in the storage area of the “model after learning (for execution)”, and the model after learning may be used in the sound production device 100.

The control unit 130 is implemented by, for example, a central processing unit (CPU), a micro processing unit (MPU) and the like executing a program (for example, an acoustic signal control program according to the present disclosure) stored in the sound production device 100 using a random access memory (RAM) and the like as a work area. The control unit 130 is a controller, and may be implemented by, for example, an integrated circuit such as an application specific integrated circuit (ASIC) and a field programmable gate array (FPGA).

As illustrated in FIG. 2, the control unit 130 includes an input unit 131, a learning unit 132, an arithmetic unit 133, a display control unit 134, and an output control unit 135, and implements or executes a function and an action of information processing described below. Note that, an internal configuration of the control unit 130 is not limited to the configuration illustrated in FIG. 2, and may be another configuration as long as information processing to be described later is performed.

The input unit 131 acquires inputs of setting and selection of various types of information (data) from the producer 200. For example, the input unit 131 acquires, from the producer 200, inputs of space data indicating a region of the virtual space 10, position coordinate data of the sound reception point and the sound production point, position coordinate data indicating the configuration of the object, a condition regarding the virtual space 10 and the like using an input means (for example, a touch panel, a keyboard, a pointing device such as a mouse, a voice input microphone, an image input camera (line of sight, gesture input) and the like) that acquires various operation inputs via the user interface on the screen provided to the producer 200.

For example, the input unit 131 acquires, from the producer 200, inputs of various settings such as a structure such as a door and a wall arranged in the virtual space 10, boundary conditions of a wall surface and the ceiling of the virtual space 10, the parameters such as the sound absorption coefficient of the object arranged in the virtual space 10, and positions of the sound production point 30 and the sound reception point 40. The input unit 131 may acquire the input of such setting from the producer 200 at a learning stage of the model 60, or the producer 200 may acquire the input of such setting at an acoustic design stage of the content to be produced after the learning of the model 60.

The input unit 131 acquires an input of a reproduction request and the like of the sound reproduced at the sound reception point 40 using the model 60 from the producer 200. For example, the input unit 131 acquires an input of selection of the sound source object to be arranged on the virtual space 10 from the producer 200.

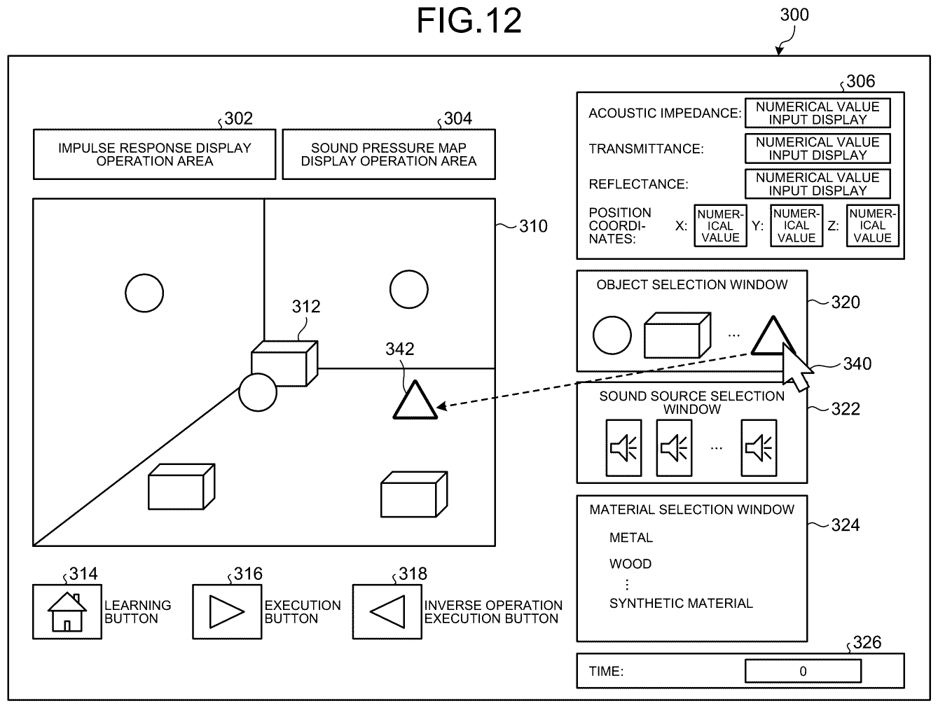

The input unit 131 acquires an input of a request regarding arrangement of the object from the producer 200. At that time, the input unit 131 may provide to the producer 200 a material and the like to be set in the object via the user interface for selecting. Such user interface is described later with reference to FIG. 12 and subsequent drawings. For example, the input unit 131 determines the structure data (parameter set for each object) in the object on the basis of an input of specification from the user of at least any one of a material, transmittance, reflectance, or position data of the object.

Note that, the input unit 131 may acquire, from the storage unit 120 or the communication unit 110, various data to be used for processing by the processing unit in the subsequent stage as necessary even without an input of explicit instruction by the producer 200 and the like. For example, the input unit 131 acquires the space data of the virtual space 10 to be processed from the storage unit 120 or the communication unit 110. Specifically, the input unit 131 acquires the space information indicating the region of the virtual space 10, the coordinate position data indicating the configuration of the object, the condition regarding the virtual space 10 and the like from the input from the user, the storage unit 120, or the communication unit 110.

The input unit 131 may acquire voice data that is a source of the sound output from the sound production point 30, which is the sound source, from the input from the producer 200, the storage unit 120, or the communication unit 110. The input unit 131 may access a database such as a library that is held in the storage unit 120 in which a sound absorption coefficient and the like for each material is recorded, and may appropriately acquire various types of information required by the processing unit in the subsequent stage. The database is stored in, for example, the storage unit 120, a server on the network N accessible via the communication unit 110, or a storage device accessible via a network device, an information device and the like. Note that, the storage unit 120 may be formed using a so-called virtualization technology in which the control unit 130 is managed in a unified storage space including a storage device accessible on the network N. In this case, the control unit 130 is stored in the storage unit 120 and can perform processing through the storage unit 120 via an operating system that performs processing by the operation of the control unit. Therefore, in the following description, unless explicitly described, the storage unit 120 also includes a storage device accessible on the network N.

The learning unit 132 performs leaning of the model 60 for reproducing the acoustic signal in the virtual space 10. The learning of the model 60 corresponds to learning of a transfer function for obtaining an impulse response in an acoustic system. Specifically, the learning unit 132 generates artificial intelligence having the acoustic data related to the sound source object arranged in the virtual space 10, the region data in the virtual space, the structure data of the object, and the position data of each object and the sound reception point at a predetermined time as inputs, and a transfer function indicating a relationship when the sound emitted by the sound source object is observed at the sound reception point 40 as an output by learning on the basis of predetermined teacher data.

As described above, the artificial intelligence according to the embodiment is a machine learning algorithm, and more specifically is a learning model (also referred to as the PINNs) in which the Green's function 64 is formed in the output layer of the DNN.

Note that, the teacher data according to the first embodiment may be data acquired on the basis of the acoustic simulation in the virtual space 10. For example, the teacher data is simulation data obtained by the FDTD method and the like in an acoustic simulator to which the setting regarding the virtual space 10 is input. Note that, the teacher data is not limited to this example, and may be, for example, acoustic data (impulse response in the first embodiment) simulated by various existing methods. The teacher data may be actual measurement data measured in a shape similar to that of the virtual space 10.

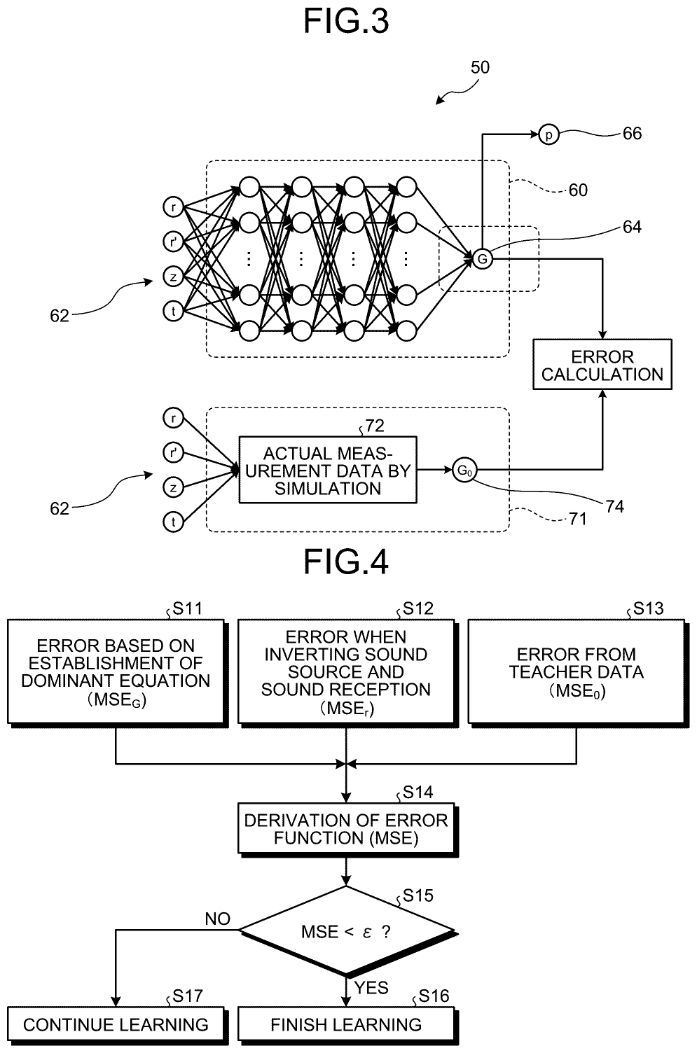

The learning unit 132 performs learning so as to minimize an error with reference to the error between the impulse response obtained by the Green's function 64 output from the model 60 and the teacher data. Such learning processing is described with reference to FIGS. 3 and 4.

FIG. 3 is a view (1) for describing the learning processing according to the first embodiment. As illustrated in FIG. 3, the learning unit 132 inputs the input information 62 as the learning data to the model 60 in the learning configuration 50, and outputs an unknown function (the Green's function 64 in the first embodiment) based on the dominant equation in the output layer.

The learning unit 132 performs known acoustic simulation based on the input information 62 in a simulation environment 71, and obtains actual measurement data 72 of the impulse response by the simulation. The learning unit 132 obtains a Green's function 74 based on the actual measurement data 72.

The learning unit 132 makes a difference between the output of the Green's function 64 and the output of the Green's function 74 an error function, calculates the error, and continues the learning of the model 60 that outputs the parameter of the Green's function 64 until the error becomes sufficiently smaller than an optionally defined threshold C. Note that, the Green's function 64 itself defines a shape of the function curve of the impulse response by the output based on a predetermined input to the model 60. That is, in the model 60, for example, a Green's function curve can be generated by complementing the curve by using outputs of n nodes arranged in a layer immediately before a node G, which is the Green's function, in FIG. 1 as n sample points in a time axis direction of the impulse response. At that time, the learning unit 132 can perform the learning by minimizing an error between a curve shape of the training model and each sample point. In this case, in a case where the above-described Green's function 74 is the n sample points based on the actual measurement data 72, the learning unit 132 can calculate the error by comparing each sample point.

Note that, in the first embodiment, not only the difference from the teacher data based on the acoustic simulation but also other errors may be used as the error function. As a result, the accuracy of the model 60 can be improved. Such processing is described with reference to FIG. 4.

FIG. 4 is a view (2) for describing the learning processing according to the first embodiment. As illustrated in FIG. 4, the learning unit 132 derives three types of values as parameters forming the error function.

First, the learning unit 132 obtains an error between the output of the Green's function 64 (that is, the impulse response according to predetermined data input) formed in the output layer of the model 60 and the dominant equation corresponding to the input of the model 60 (Step S11). That is, the learning unit 132 calculates feasibility of the dominant equation (difference of the differential equation) in the PINNs as an error MSE_{G}, which is one of the parameters of the error function.

Note that, the transfer function in the sound field is expressed by following expression (1) in a case where the sound reception point position is represented by r, the sound source position is represented by r′, the time is represented by t, a certain differential operator is represented by L, a field amount such as potential is represented by ϕ, and an output force or a wave source such as the sound source is represented by ζ. In the following embodiments, an example based on an orthogonal coordinate system is described, but a polar coordinate system may be used. In a case where the polar coordinate system is used for the coordinate data, each expression described below may be appropriately converted into an expression corresponding to the polar coordinate.

$${L}_{ϕ} ( r , t ) = - ζ ( r , t ) \qquad ( 1 )$$

In this case, the Green's function G in the sound field is expressed by following expression (2).

$$LG ( r , {r}^{′} , t ) = - δ ( ( r , t ) - ( {r}^{′} , t ) ) \qquad ( 2 )$$

In expression (2) mentioned above, the Green's function G satisfies any boundary condition out of the Dirichlet boundary condition, the Neumann boundary condition, and the Robin boundary condition in consideration of reflection and sound absorption as the boundary condition. For example, the Dirichlet boundary condition satisfies the condition of following expression (3).

$$G ( r , {r}^{′} , t ) = 0 \qquad ( 3 )$$

The Neumann boundary condition satisfies the condition of following expression (4). Note that, n in expression (4) represents a normal vector directed outside the boundary surface.

$$\frac{dG ( r , {r}^{′} , t )}{dn} = 0 \qquad ( 4 )$$

The Robin boundary condition satisfies the condition of following expression (5). Note that, A and B in expression (5) represent constants other than 0.

$$AG ( r , {r}^{′} , t ) + B \frac{dG ( r , {r}^{′} , t )}{dn} = 0 \qquad ( 5 )$$

When the Green's function G is expressed by above-mentioned expression (2), an expression expressing establishment of the dominant equation is expressed by following expression (6).

$$LG ( r , {r}^{′} , t ) = - δ ( ( r , t ) - ( {r}^{′} , t ) ) \qquad ( 6 )$$

From above-mentioned expression (6), an error MSE_{G}, which is one of the parameters of the error function, is expressed by following expression (7).

$${MSE}_{G} = \frac{1}{{N}_{G ( r , {r}^{′} , t )}} {\sum }_{r = 1}^{{N}_{G ( r , {r}^{′} , t )}} {[ G ( r , {r}^{′} , t ) ]}^{2} \qquad ( 7 )$$

As illustrated in FIG. 4, the learning unit 132 may use a difference between the output (that is, the impulse response) from the Green's function 64 that is the output layer of the model 60 and the output from the Green's function obtained in a case where the data obtained by inverting the sound production point and the sound reception point in the input information is input to the model 60 as an error MSEᵣ that is one parameter of the error function (Step S12). This is based on an idea that a difference between an original value and an inverted value is used as an evaluation function on the premise that the transfer function is established even if the positions of the sound production point and the sound reception point are inverted. The error MSEᵣ is expressed by, for example, following expression (8).

$${MSE}_{r} = \frac{1}{{N}_{G ( r , {r}^{′} , t )}} {\sum }_{{r}^{′} = 1}^{{N}_{G ( r , {r}^{′} , t )}} {[ G ( r , {r}^{′} , t ) - G ( r , {r}^{′} , t ) ]}^{2} \qquad ( 8 )$$

As illustrated in FIG. 4, the learning unit 132 calculates an error MSE₀ that is a difference between the output of the Green's function 64 that is the output layer of the model 60 and the teacher data, for example, on the basis of following expression (9) (Step S13).

$${MSE}_{0} = \frac{1}{{N}_{G ( r , {r}^{′} , t )}} {\sum }_{r = 1}^{{N}_{G ( r , {r}^{′} , t )}} {[ {G}_{0} ( r , {r}^{′} , t ) - G ( r , {r}^{′} , t ) ]}^{2} \qquad ( 9 )$$

The learning unit 132 derives an error function MSE including these three parameters (Step S14). That is, the error function MSE is expressed by, for example, following expression (10).

$$MSE = {MSE}_{G} + {MSE}_{r} + {MSE}_{0} \qquad ( 10 )$$

The learning unit 132 determines whether a solution of expression (10) becomes a value smaller than the threshold ε (Step S15). In a case where the solution of expression (10) is smaller than the threshold ε (Step S15; Yes), the learning unit 132 determines that the learning is sufficiently performed and finishes the learning (Step S16). In contrast, in a case where the solution of expression (10) is larger than the threshold ε (Step S15; No), the learning unit 132 determines that the learning is insufficient and continues the learning (Step S17).

As described above, the learning unit 132 performs learning of the model 60 so as to minimize the sum of the error MSE_{G}, which is the error between the output of the Green's function 64 that is the output layer of the model 60 and the output of the dominant equation corresponding to the input, the error MSEᵣ between the output of the Green's function 64 that is the output layer of the model 60 and the output of the Green's function 64 in a case where the position data of the sound production point and the sound reception point is inverted, and the error MSE₀ between the teacher data and the output of the Green's function 64. As a result, the learning unit 132 can perform learning of the model 60 capable of reproducing the space with high accuracy. Note that, the learning method of the model 60 is not limited to the above-described example. For example, the learning unit 132 may perform learning of the model 60 using an adversarial learning method and the like referred to as a generative adversarial network (GAN).

Note that, as described above, since the boundary condition is included in the input in the learning of the model 60, this is independent from the error function expressed by expression (10). Therefore, the error function is not affected by the boundary condition and does not change depending on the boundary condition.

Returning to FIG. 2, the description is continued. The arithmetic unit 133 performs various operations using the model 60. The model 60 is a model trained by the learning processing, and is stored in the storage area of the “model after learning (for execution)” of the storage unit 120, for example, as described above, and can be accessed by the arithmetic unit 133. For example, the arithmetic unit 133 inputs a plurality of types of data including the sound reception point 40 acquired by the input unit 131 to the model 60, and derives the Green's function 64 corresponding to the impulse response at the sound reception point 40 using the parameter output from the model 60.

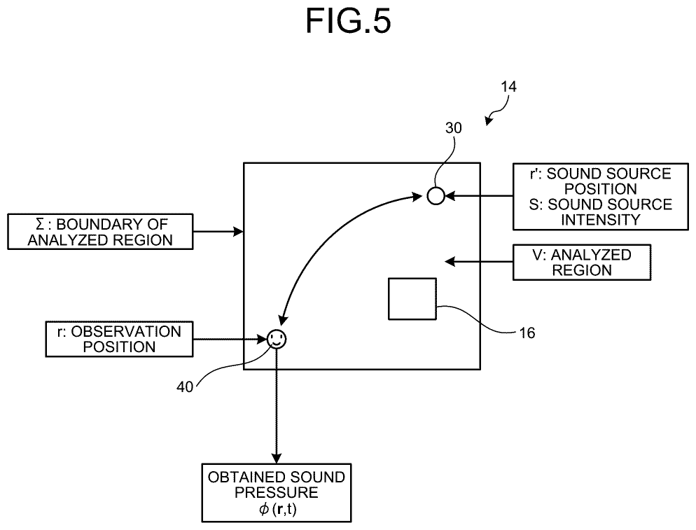

The arithmetic unit 133 can also calculate the sound pressure 66 at the sound reception point 40 by an operation by performing predetermined function conversion on the basis of the Green's function 64 formed in the output layer of the model 60. This point is described with reference to FIG. 5. FIG. 5 is a view for describing arithmetic processing according to the first embodiment.

FIG. 5 is a plan view illustrating a virtual space 14 to be calculated by the arithmetic unit 133. In the example in FIG. 5, the arithmetic unit 133 calculates the sound pressure at the sound reception point 40 of the sound transmitted from the sound production point 30.

In the example illustrated in FIG. 5, in a case where the sound pressure obtained by the arithmetic unit 133 is expressed by an observation position (coordinates) r and a function Φ of time t, when the boundary of a region to be analyzed (virtual space 14) is represented by Σ, the coordinates of the sound source position are represented by r′, the intensity of the sound source is represented by S, and the volume of the region to be analyzed is represented by V, the function (is expressed by following expression (11).

$$ϕ ( r , t ) = {\int }_{0}^{t} {dt}^{′} {\int }_{V} ( {dr}^{′} ) G ( r , t ; {r}^{′} , {t}^{′} ) S ( {r}^{′} , t ) - {\int }_{0}^{t} {dt}^{′} {\int }_{Σ} d σ [ G ( r , t ; {r}^{′} , {t}^{′} ) {∇}^{′} ϕ ( {r}^{′} , {t}^{′} ) - ϕ ( {r}^{′} , {t}^{′} ) {∇}^{′} G ( r , t ; {r}^{′} , {t}^{′} ) ] - \frac{1}{{C}^{2}} {\int }_{V} ( {dr}^{′} ) [ G ( r , t ; {r}^{′} , {t}^{′} ) {\partial }_{t = 0} ϕ ( {r}^{′} , 0 ) - ϕ ( {r}^{′} , 0 ) {\partial }_{t = 0} G ( r , t ; {r}^{′} , {t}^{′} ) ] \qquad ( 11 )$$

The arithmetic unit 133 calculates the sound pressure at the sound reception point 40 on the basis of above-mentioned expression (11). As a result, the arithmetic unit 133 can also obtain the sound pressure at the sound reception point 40 in consideration of the influence even in the virtual space 14 including a structure such as an object 16.

Returning to FIG. 2, the description is continued. The display control unit 134 controls the output unit 140 to output various types of information. Specifically, the display control unit 134 controls a display 150 to display the user interface and the like used by the producer 200.

The output control unit 135 controls the output unit 140 to output various types of information, similarly to the display control unit 134. Specifically, in a case where the input unit 131 acquires an input of a voice reproducing operation by the producer 200 via the user interface, the output control unit 135 controls a speaker 160 to output the acoustic signal in response to the request.

For example, the output control unit 135 outputs a reproduced sound at the sound reception point 40 of the sound transmitted from the sound production point 30 on the basis of an arithmetic result by the arithmetic unit 133. Specifically, the output control unit 135 outputs the acoustic signal from the speaker 160 on the basis of the sound pressure at the sound reception point 40 calculated from the impulse response at the sound reception point 40.

The output unit 140 outputs various types of information. As illustrated in FIG. 2, the output unit 140 includes the display 150 and the speaker 160. Under the control of the display control unit 134, the display 150 displays the virtual space 10 to be processed, and displays the user interface for the input unit 131 to acquire an operation input from the producer 200. The speaker 160 outputs the acoustic signal and the like generated from the arithmetic result under the control of the output control unit 135.

### 1-3. Procedure of Information Processing According to First Embodiment

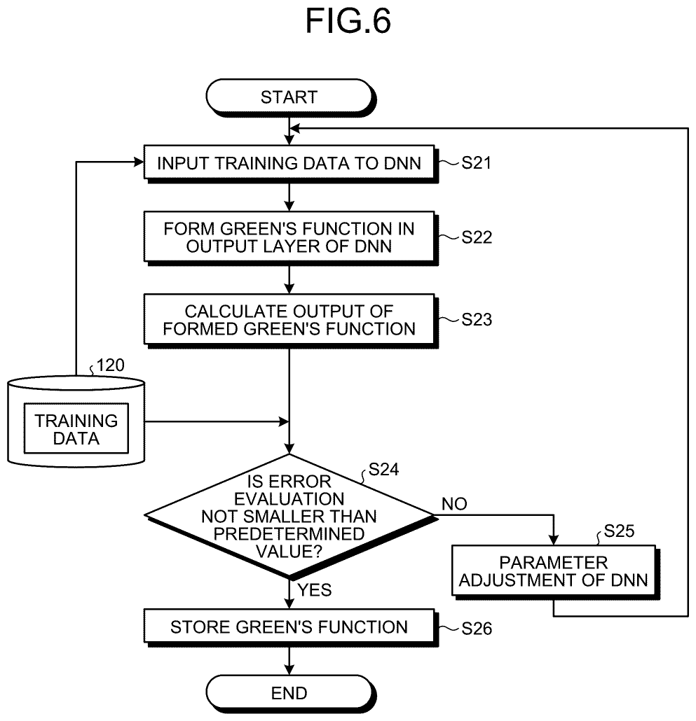

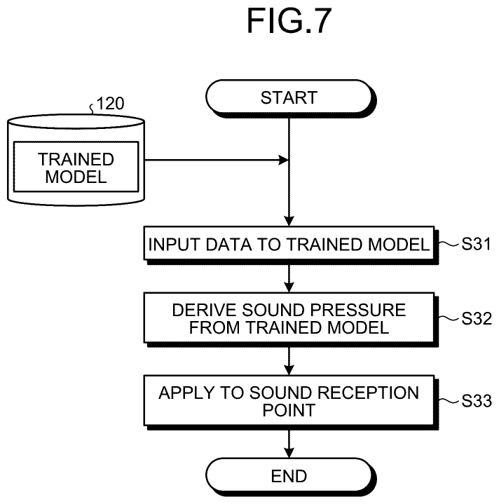

Next, a procedure of the information processing according to the first embodiment is described with reference to FIGS. 6 and 7.

First, a procedure of the learning processing according to the first embodiment is described with reference to FIG. 6. FIG. 6 is a flowchart illustrating the procedure of the learning processing according to the first embodiment.

The sound production device 100 inputs the training data to the model 60 used for learning, specifically, the input layer of the DNN (Step S21). The training data is data that might be necessary for the learning processing of forming the Green's function in the output layer of the DNN, and includes, for example, position coordinate data of the sound production point and the sound reception point, position coordinate data indicating the structure of the space, the boundary condition such as the acoustic impedance of the structure, the time parameter and the like.

The sound production device 100 forms the Green's function in the output layer of the DNN (Step S22). Subsequently, the sound production device 100 executes an operation for performing an impulse response output corresponding to a predetermined time from the formed Green's function (Step S23).

Thereafter, the sound production device 100 calculates an error on the basis of the error function expressed by above-mentioned expression (10), such as an error between the training data acquired from the storage unit 120 and an arithmetic result for performing the impulse response output corresponding to a predetermined time from the above-described Green's function, and determines whether an error evaluation is a predetermined value or larger or not (Step S24). Note that, the error evaluation is, namely, an error amount, and the predetermined value corresponds to any value such as the threshold ε illustrated in FIG. 4.

In a case where the error evaluation is lower than the predetermined value (Step S24; No), the sound production device 100 adjusts the parameter of the DNN (Step S25), and returns to S21 again to repeat the learning processing.

In contrast, in a case where the error evaluation is the predetermined value or larger (Step S24; Yes), the sound production device 100 finishes the learning and stores the derived Green's function in the storage unit 120 (Step S26).

Next, a procedure of the arithmetic processing according to the first embodiment is described with reference to FIG. 7. FIG. 7 is a flowchart illustrating the procedure of the arithmetic processing according to the first embodiment.

The sound production device 100 acquires the trained model 60 held in the storage unit 120 and inputs data to the acquired trained model 60 (Step S31). The data includes the position coordinate data of the sound production point and the sound reception point in the virtual space for which the operation is to be performed, the position coordinate data indicating the structure of the space, the boundary condition such as the acoustic impedance of the structure, the time and the like.

The sound production device 100 applies expression (11) on the basis of the impulse response that is the output of the Green's function formed in the output layer of the model 60 and performs an operation to derive the sound pressure (Step S32). The sound production device 100 further calculates the sound pressure at the sound reception point by applying data such as the position coordinate data of the sound reception point to expression (11) (Step S33).

### 1-4. Execution Example of Information Processing According to First Embodiment

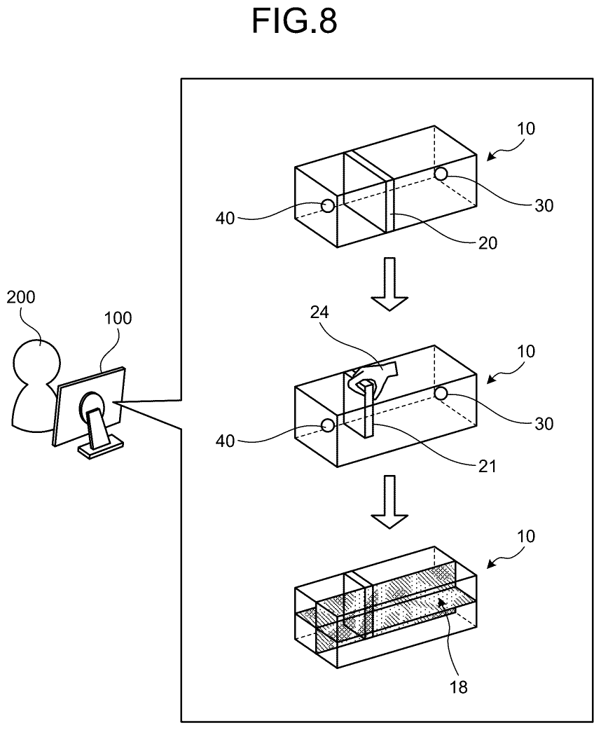

The sound production device 100 can obtain the acoustic signal at the sound reception point in real time even in a virtual space a structure of which changes according to time by using the trained model 60. Such example is described with reference to FIG. 8.

FIG. 8 is a view illustrating another example of the arithmetic processing according to the first embodiment. FIG. 8 illustrates an example in which there is a structure (object), which is a wall 20, between the sound production point 30 and the sound reception point 40 in the virtual space 10.

In this example, the producer 200 executes processing of deleting a half of the wall 20 by operating a cursor 24 displayed on the user interface while reproducing the acoustic signal at the sound reception point 40. By this operation, the wall 20 that interrupts between the sound production point 30 and the sound reception point 40 in the virtual space 10 changes to a wall 21 having a half volume of the wall 20.

The sound production device 100 substitutes data reflecting such change into the model 60 having the Green's function in the output layer. Specifically, the sound production device 100 inputs position coordinate data (structure data in the virtual space 10) when the wall 20 changes to the wall 21 to the model 60 having the Green's function in the output layer, and recalculates an output value at the sound reception point 40. That is, the sound production device 100 obtains a sound pressure distribution after the change of the structure in the virtual space 10 as illustrated in a distribution 18.

As a result, the producer 200 can confirm in real time what type of sound change occurs at the sound reception point 40 in a case where the wall 20 is changed in the virtual space 10. That is, in the virtual space 10, the sound at the sound reception point 40 continuously changes by the change of the structure of the wall 20 arranged at the center. The producer 200 can operate the change via the user interface, and can listen to the sound at the sound reception point 40 that continuously changes following the same. In this manner, according to the sound production device 100, workability of the acoustic design of the producer 200 can be improved.

### 2. Second Embodiment

### 2-1. Outline of Information Processing According to Second Embodiment

Next, a second embodiment is described. In the first embodiment, the sound production device 100 reproduces the acoustic signal at the sound reception point by generating the model 60 having the Green's function that outputs the data corresponding to the impulse response in the output layer by the learning processing. Here, on the basis of the trained model 60 in the first embodiment, the producer 200 can perform acoustic design by inputting a desired impulse response in a virtual space, that is, by inputting an ideal sound in the virtual space as a condition. For example, the producer 200 specifies a shape of a function of the impulse response using a user interface. The sound production device 100 extracts n sample values, as many as input nodes of the trained model 60, from the specified shape of the function and inputs the same to each node. In the second embodiment, it is assumed that the trained model of the first embodiment has a function of performing an inverse operation at input/output of each node. That is, a sound production device 100 according to the second embodiment receives the input at the output of each node of the first embodiment, and performs the inverse operation at each node to generate the output, for example. By providing the trained model 60 with an inverse operation function, the sound production device 100 can estimate a parameter that an outer shape of a specific structure in an environment should have in a case where an output of a predetermined impulse response is made a condition. For example, the sound production device 100 sets a certain structure as a processing target, thereby generating an acoustic parameter that satisfies the same. In addition, the second embodiment includes generation of the model for the purpose of obtaining derivation of an ideal shape obtained by changing an appearance shape by changing the shape of the structure.

The sound production device 100 according to the second embodiment is provided with the inverse operation different from the operation according to the first embodiment in the trained model 60, and can output condition data of an acoustic environment having the impulse response as the input by performing the inverse operation. That is, in a case where the trained model 60 is made the DNN in the first embodiment, the sound production device 100 can newly set the output layer in which the Green's function is formed in the first embodiment as an input layer, regard the input layer including the acoustic impedance z in the first embodiment as an output layer, proceed with a flow of data calculation in a direction from the output layer (that is, the input layer of the second embodiment) to an intermediate layer and from the intermediate layer to the input layer (the output layer of the second embodiment), and finally output the acoustic impedance z, which is one of the data of the input layer of the first embodiment. That is, the sound production device 100 according to the second embodiment can generate the acoustic impedance of a system as the output in the input layer of the model 60 of which learning is performed in the first embodiment by acquiring the data of the impulse response in the input unit 131, inputting the acquired data to the output layer of the trained model, and performing the inverse operation described above at each node in the model 60 of the first embodiment on the basis of the model 60 trained in the first embodiment. As a result, the sound production device 100 can establish a virtual space in which a producer 200 implements an ideal impulse response. According to the sound production device 100, in order to implement the ideal impulse response, data such as arrangement (position coordinates) of a new object for bringing the acoustic impedance of an entire system close to an ideal value can be output and presented to the producer 200.

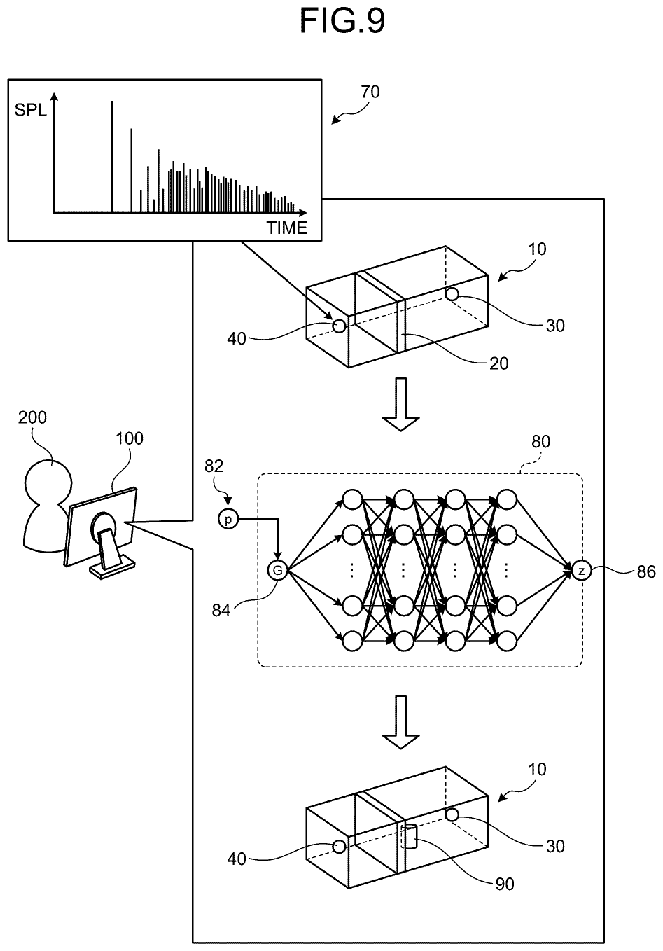

Such processing is described with reference to FIG. 9. FIG. 9 is a view illustrating an outline of information processing according to the second embodiment. Similarly to the first embodiment, the sound production device 100 provides the producer 200 with a user interface in which a virtual space 10 is displayed.

The virtual space 10 includes a sound production point 30, a sound reception point 40, and a wall 20. In the virtual space 10, the producer 200 inputs a desired impulse response 70 as sound of sound reproduced at the sound reception point 40. Note that, the producer 200 may input the impulse response created by him/herself, or may select an existing impulse response in which reverberation information and the like according to various environments are preset from a library.

The sound production device 100 inputs data of the impulse response 70 to an input layer of a model 80 as input information. Note that, the model 80 is a DNN having a Green's function in a part of an input layer, and has an inverse operation function different from the operation of the first embodiment at each node of the trained model 60 in the first embodiment. The sound production device 100 can convert a sound pressure 82 into an impulse response and then input the same to a Green's function 84 formed in the input layer of the model 80.

In this embodiment, the trained model 80 outputs an acoustic impedance 86, which is a boundary condition. That is, the model 80 outputs the acoustic impedance in the virtual space 10 for implementing the ideal impulse response 70 at the sound reception point 40. Note that, although the acoustic impedance is output in this embodiment, in the output of the model 80, any of the inputs (that is, inputs of space information indicating a region of the virtual space 10, position coordinate data indicating a configuration of the object, and a condition regarding the virtual space 10) at the time of learning of the model 60 can be output.

Thereafter, the sound production device 100 may arrange a new object 90 in the virtual space 10 on the basis of the output acoustic impedance 86. That is, the sound production device 100 can change the virtual space 10 so that the boundary condition satisfies the acoustic impedance 86 as the entire system by adding the object 90 to the virtual space 10. As described above, specific information (position coordinates, structure data (for example, a material) and the like) of a predetermined sound source object in the virtual space 10 may be output instead of the acoustic impedance 86 in the model 80.

As described above, the sound production device 100 according to the second embodiment acquires an input of a request (for example, specification of a desired impulse response) regarding the output of the acoustic signal desired by the producer 200. In a case of acquiring the input of the request, the sound production device 100 inputs the output of the acoustic signal desired by the producer 200 to the model 80, and outputs at least any one of information (for example, the acoustic impedance) regarding the virtual space 10 or the object required for implementing the output of the acoustic signal desired by the producer 200 or information regarding the sound source object from the output data. As the information regarding the virtual space 10 or the object, the sound production device 100 outputs at least any one of a change in boundary condition of the space to be analyzed, a change in structure data of the object already arranged, or structure data of an object that should be newly arranged in the virtual space 10.

As a result, the sound production device 100 can implement the acoustic design that satisfies the ideal of the producer 200. The producer 200 can implement the ideal sound that he/she envisions without taking time and effort of manually replacing the arrangement of the object in the virtual space 10.

### 2-2. Procedure of Information Processing According to Second Embodiment

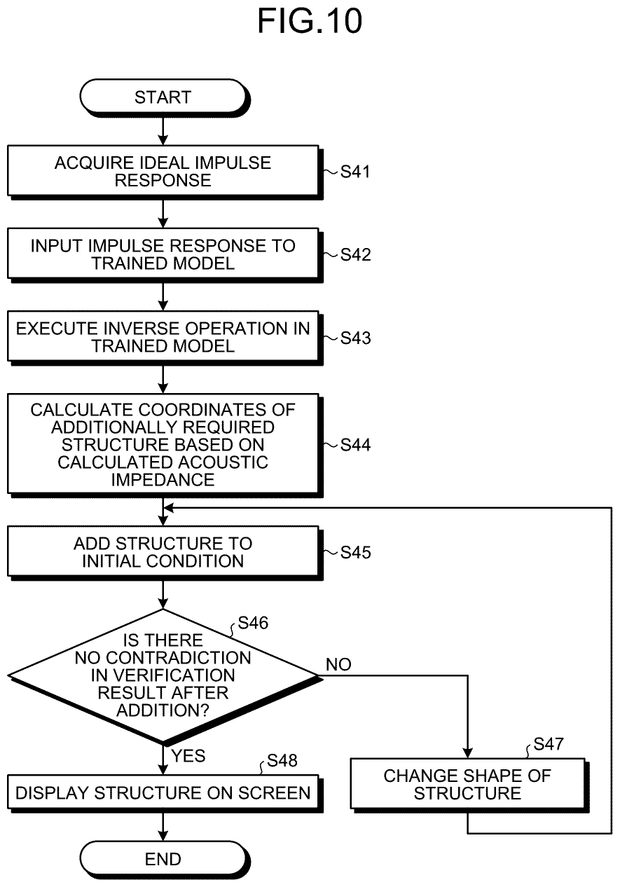

Next, a procedure of the information processing according to the second embodiment is described with reference to FIG. 10. FIG. 10 is a flowchart illustrating the procedure of the information processing according to the second embodiment.

The sound production device 100 acquires the data input of the impulse response ideal for the acoustic output in the sound production device in accordance with an instruction of the producer 200 via the user interface (Step S41). For example, the data of the ideal impulse response may be acquired from a server on a network via a communication unit 110, or may be acquired from a predetermined storage area of a storage unit 120 to be input. The producer 200 may separately input via the input unit 131. The sound production device 100 inputs the input impulse response data to the model 80 (that is, the Green's function formed in the input layer of the model 80) (Step S42).

Subsequently, the sound production device 100 performs an inverse operation toward the input layer of the DNN including obtaining the parameter of the Green's function formed in the input layer of the model 80 by the inverse operation (Step S43). With such processing, the sound production device 100 can calculate the acoustic impedance in the virtual space 10 on the basis of the trained model 80.

Thereafter, the sound production device 100 calculates coordinates of a structure that is additionally required on the basis of the calculated acoustic impedance (Step S44). The sound production device 100 adds the added structure to an initial condition (Step S45). For example, the sound production device 100 adds the position coordinate data, the acoustic impedance and the like of the added structure to the initial condition.

After adding the structure, the sound production device 100 verifies whether there is a contradiction in the virtual space 10 (Step S46). For example, the sound production device 100 verifies whether the impulse response at the sound reception point 40 can be maintained or whether there is no change in the acoustic impedance of the entire virtual space 10 by arranging the additional structure.

In a case where there is the contradiction in a verification result (Step S46; Yes), the sound production device 100 changes a shape of the added structure (Step S47), and adds the information of the structure to the initial condition again.

In contrast, in a case where there is no contradiction in the verification result (Step S46; No), the sound production device 100 displays the structure on a screen including the user interface (Step S48).

Note that, although the example in which a physical amount obtained by the sound production device 100 is the acoustic impedance is described above, the sound production device 100 may output other physical amounts by the inverse operation based on the trained model. For example, the sound production device 100 is configured to output the acoustic impedance on the basis of the ideal impulse response. In contrast, the position coordinate data of the sound production point 30 (sound source position) of the sound for obtaining the ideal impulse response may be calculated by the inverse operation based on the trained model. As a result, the sound production device 100 can output the position data of the sound source object in which the output of the acoustic signal desired by the producer 200 is implemented at the sound reception point 40 as the information regarding the object after the change in the virtual space.

Alternatively, the sound production device 100 may satisfy the ideal boundary condition by changing the position data of the existing object. For example, when implementing the acoustic impedance in the virtual space 10, the sound production device 100 may set a certain structure as a processing target and generate a model for the purpose of obtaining an ideal shape that changes only the shape of the target structure.

### 3. Third Embodiment

The information processing described in the first and second embodiments may be executed via the user interface provided by the sound production device 100. Information processing via such user interface is described as a third embodiment.

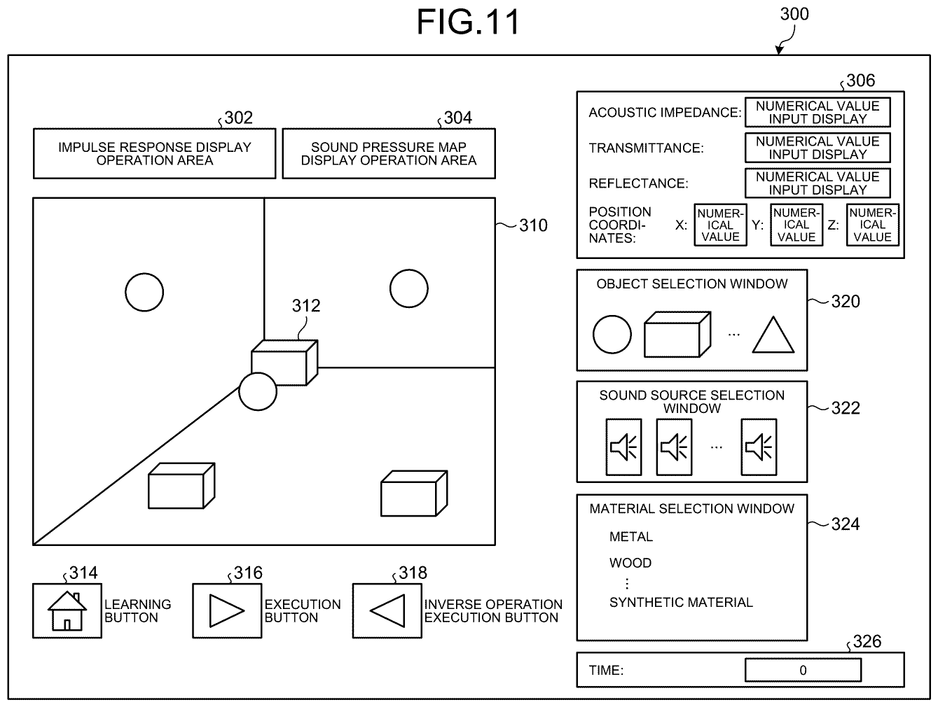

FIG. 11 is a view (1) illustrating an example of a user interface 300 provided by a sound production device 100. FIG. 11 illustrates a display example of the user interface 300 displayed on a display and the like connected to the sound production device 100.

The user interface 300 is used in a case where a producer 200 causes the sound production device 100 to execute learning processing, a case where an acoustic design of a virtual space in a content is executed using a trained model or the like.

The user interface 300 includes, for example, an impulse response display operation area 302. In the impulse response display operation area 302, for example, a waveform graph and the like indicating the impulse response indicated as the arithmetic result according to the first embodiment is displayed.

Alternatively, in a case where the sound production device 100 executes arithmetic processing according to the second embodiment, a waveform of the impulse response ideal for the producer 200 is displayed in the impulse response display operation area 302. For example, the producer 200 causes the sound production device 100 to read a file holding the ideal impulse response, thereby displaying a waveform indicating the impulse response in the impulse response display operation area 302. The producer 200 can edit the impulse response displayed in the impulse response display operation area 302.

The user interface 300 includes a sound pressure map display operation area 304. In the sound pressure map display operation area 304, for example, a sound pressure distribution and the like indicated as the arithmetic result according to the first embodiment is displayed.

The user interface 300 includes a condition display area 306. In the condition display area 306, information of each condition set in the virtual space being edited is displayed. In a case where the producer 200 selects any object, information of each condition set for the object is displayed in the condition display area 306.

In the condition display area 306, the producer 200 can input various conditions to be set in the virtual space in the content. For example, the producer 200 can input acoustic impedance, transmittance, reflectance, position coordinates and the like of the virtual space and each object arranged in the virtual space.

The user interface 300 includes a virtual space display area 310. In the virtual space display area 310, a situation of the virtual space designed by the producer 200 is displayed. For example, the virtual space display area 310 displays a texture of a wall surface or the ceiling of the virtual space, an object 312 arranged in the virtual space and the like. Note that, although FIG. 11 illustrates the virtual space displayed in the virtual space display area 310 in three dimensions, the virtual space may be displayed in two dimensions such as a plan view.

The user interface 300 includes a learning button 314, an execution button 316, and an inverse operation button 318. The learning button 314 is a button for causing the sound production device 100 to execute the learning processing described in the first and second embodiments in the virtual space designed by the producer 200. The execution button 316 is a button for causing the sound production device 100 to execute the arithmetic processing described in the first embodiment in the virtual space designed by the producer 200. The inverse operation button 318 is a button for causing the sound production device 100 to execute the arithmetic processing described in the second embodiment in the virtual space designed by the producer 200.

The user interface 300 includes an object selection window 320. In the object selection window 320, an object that can be arranged in the virtual space by the producer 200 is displayed. The producer 200 can arrange the object in the virtual space by selecting a desired object and moving the same to the virtual space display area 310. In a case where the object is arranged, the sound production device 100 acquires position coordinate data and shape information of such object and stores the position coordinate data in the virtual space.

The user interface 300 includes a sound source selection window 322. In the sound source selection window 322, a sound source object that can be arranged in the virtual space by the producer 200 is displayed. The sound source object may include various types of information regarding an acoustic signal to be emitted, such as the sound pressure, tone, and directivity, in advance. The producer 200 can arrange the sound source object in the virtual space by selecting a desired sound source object and moving the same to the virtual space display area 310. In a case where the sound source object is arranged, the sound production device 100 acquires the position coordinate data, sound pressure, and tone information of such sound source object and stores the same as a sound production point in the virtual space.

The user interface 300 includes a material selection window 324. In the material selection window 324, a material that can be set in the object arranged in the virtual space by the producer 200 is displayed. The producer 200 can select a desired material and apply the material to the object arranged in the virtual space display area 310, thereby providing a condition (acoustic impedance, sound absorption coefficient and the like) to the object.

In this manner, the sound production device 100 acquires the input of the request regarding the arrangement of the object from the producer 200 by the input unit 131 via the user interface 300. The sound production device 100 determines the structure data of the object in the virtual space on the basis of specification from the producer 200 of at least any one of a material, transmittance, reflectance, or position data of the object included in the input of the request. That is, the producer 200 can give a condition to the object by selecting a familiar material without specifying a numerical value such as the acoustic impedance, so that a work of acoustic design can be easily performed. Note that, in a case where the input unit 131 acquires the input of the request regarding the arrangement of the object from the producer 200, the sound production device 100 may output the acoustic signal at the sound reception point recalculated on the basis of the structure data of the object after being changed by the request. As a result, the producer 200 can confirm a change caused by an operation such as arrangement of the object in real time, so that workability of acoustic design is improved.

The user interface 300 includes a time display area 326. In the time display area 326, time information in a case where various types of processing are executed is displayed. For example, in a case where the sound production device 100 is caused to calculate the impulse response and the sound pressure at any sound reception point and the acoustic signal based on an arithmetic result is reproduced, a lapse of a reproduction time is displayed in the time display area 326.

An operation example executable by the producer 200 in the user interface 300 is described with reference to FIGS. 12 to 17. FIG. 12 is a view (1) illustrating an operation example in the user interface 300.

As illustrated in FIG. 12, in the user interface 300, the producer 200 operates a cursor 340 and selects an object desired to be arranged in the virtual space from the object selection window 320. The producer 200 moves a selected object 342 to the virtual space display area 310 by a drag operation and the like.

The sound production device 100 acquires shape information regarding the arranged object 342 and position data (position coordinate data) of the object 342 arranged in the virtual space. The sound production device 100 updates region data in the virtual space on the basis of the acquired information. In this manner, the producer 200 can quickly form a desired virtual space by using the user interface 300.

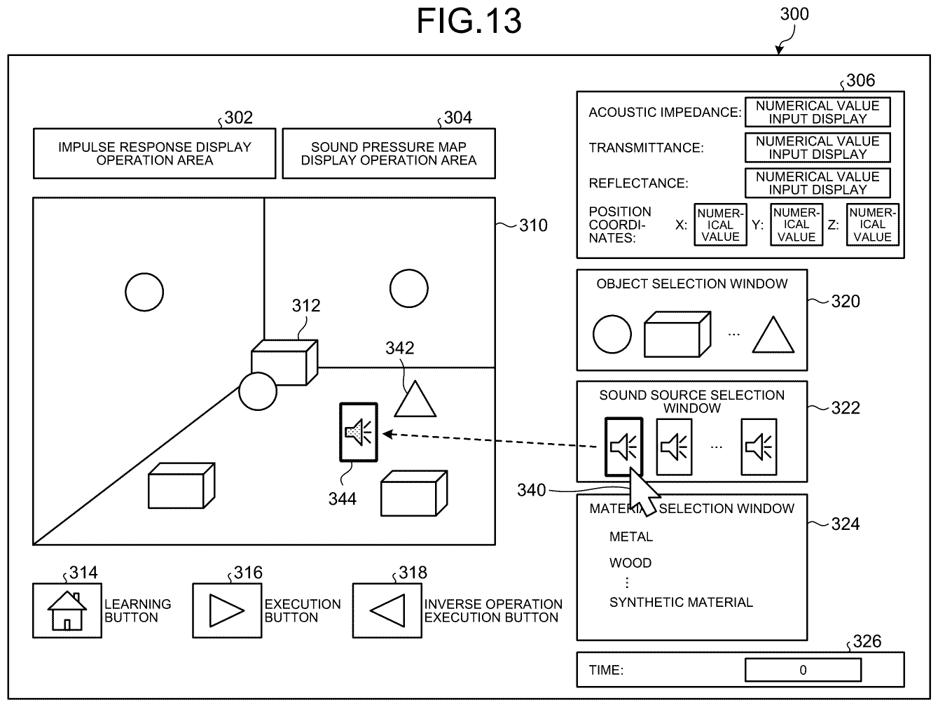

Subsequently, another operation example is described with reference to FIG. 13. FIG. 13 is a view (2) illustrating an operation example in the user interface 300.

As illustrated in FIG. 13, in the user interface 300, the producer 200 operates the cursor 340 and selects the sound source object desired to be arranged in the virtual space from the sound source selection window 322. The producer 200 moves a selected sound source object 344 to the virtual space display area 310 by a drag operation and the like.

The sound production device 100 acquires sound information set in the arranged sound source object 344 and position data (position coordinate data) of the sound source object 344 arranged in the virtual space. The sound production device 100 updates the sound production point in the virtual space on the basis of the acquired information. In this manner, the producer 200 can visually set from where of the virtual space the sound is transmitted by using the user interface 300.

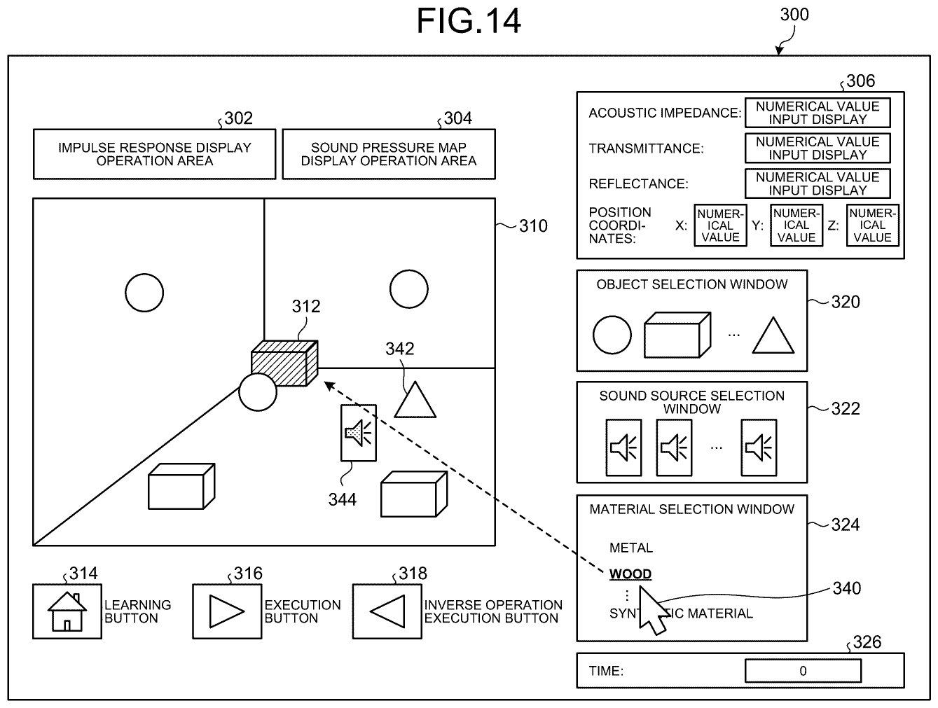

Subsequently, another operation example is described with reference to FIG. 14. FIG. 14 is a view (3) illustrating an operation example in the user interface 300.

As illustrated in FIG. 14, in the user interface 300, the producer 200 operates the cursor 340 and selects a material set as the object from the material selection window 324. The producer 200 moves the selected material toward the object 312 arranged in the virtual space display area 310 by a drag operation and the like.

When the cursor 340 is superimposed on the object 312, the sound production device 100 applies the selected material to the object 312. Specifically, the sound production device 100 applies boundary conditions such as acoustic impedance and sound absorption coefficient set for each material to the object 312. The sound production device 100 updates the boundary condition in the entire virtual space on the basis of the acquired information. In this manner, the producer 200 can execute numerical value setting and the like of the acoustic impedance, which is generally difficult, by an intuitive operation of selecting the material by using the user interface 300.

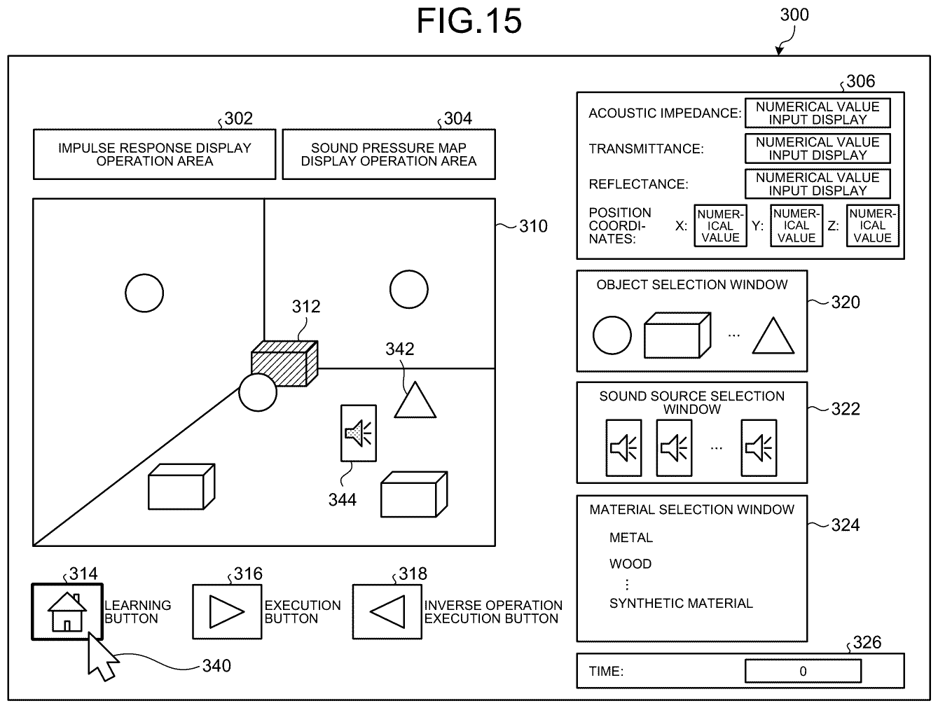

Subsequently, another operation example is described with reference to FIG. 15. FIG. 15 is a view (4) illustrating an operation example in the user interface 300.

As illustrated in FIG. 15, in the user interface 300, after the formation of the virtual space and the setting of the sound reception point and the sound production point are completed, the producer 200 operates the cursor 340 and presses the learning button 314. When the learning button 314 is pressed, the sound production device 100 executes learning processing under a set environment. Note that, in the learning processing, the sound production device 100 may perform processing of automatically performing a plurality of trials while gradually changing the positions of the sound reception point and the sound production point.

In this manner, by performing learning in a state in which a specific boundary condition is set, the sound production device 100 can perform learning of a model corresponding to the specific boundary condition. For example, the sound production device 100 may hold a trained model suitable for each environment, such as a trained model trained under an environment in which a narrow room is assumed or a model trained under an environment close to a free sound field. As a result, the sound production device 100 can calculate the acoustic signal with higher accuracy by using the trained model suitable for arithmetic processing to be described later.

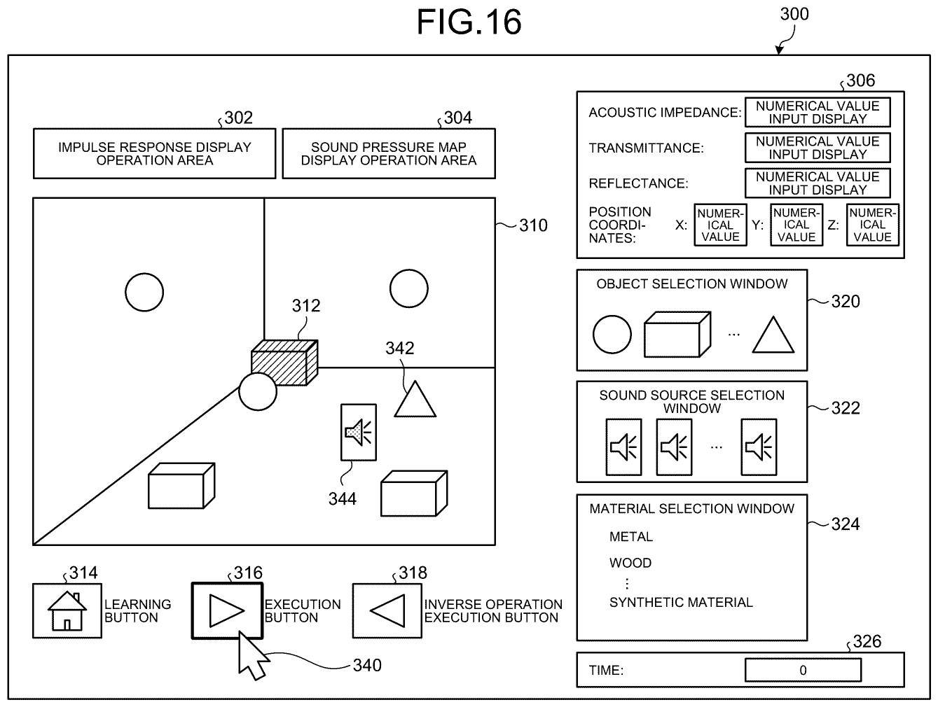

Subsequently, another operation example is described with reference to FIG. 16. FIG. 16 is a view (5) illustrating an operation example in the user interface 300.

As illustrated in FIG. 16, in the user interface 300, after the formation of the virtual space and the setting of the sound reception point and the sound production point are completed, the producer 200 operates the cursor 340 and presses the execution button 316. When the execution button 316 is pressed, the sound production device 100 executes arithmetic processing under a set environment. Specifically, the sound production device 100 inputs position coordinate data of the set sound reception point or sound production point, the boundary condition of the virtual space and the like to the trained model 60, and derives the impulse response at the sound reception point. Furthermore, the sound production device 100 calculates the sound pressure at the sound reception point from the derived impulse response. The sound production device 100 generates the acoustic signal on the basis of an arithmetic result and outputs the generated acoustic signal from a speaker and the like.

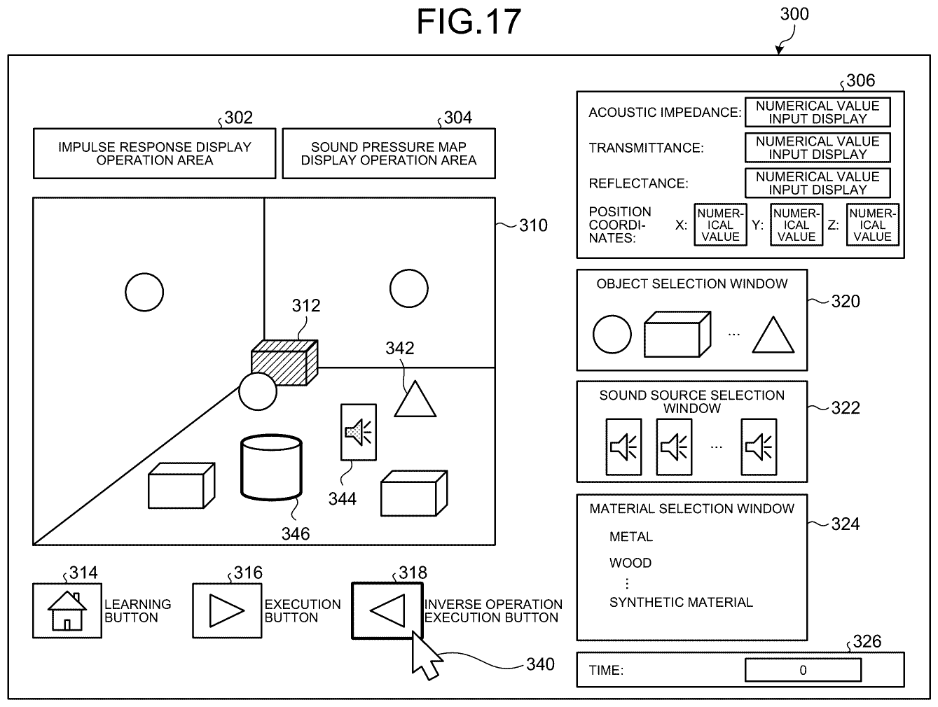

Subsequently, another operation example is described with reference to FIG. 17. FIG. 17 is a view (6) illustrating an operation example in the user interface 300.

As illustrated in FIG. 17, in the user interface 300, the producer 200 completes the formation of the virtual space and the setting of the sound reception point and the sound production point, and further sets the ideal impulse response at the sound reception point, then operates the cursor 340 and presses the inverse operation button 318. When the inverse operation button 318 is pressed, the sound production device 100 performs an inverse operation of the boundary condition for implementing the impulse response ideal for the producer 200. Specifically, the sound production device 100 inputs position coordinate data of the set sound reception point or sound production point, the impulse response set by the producer 200 to the DNN of which pre-learning is performed and acquires the boundary condition output from the DNN.

The sound production device 100 calculates a shape of an object 346, a boundary condition, a shape and the like required for implementing the acquired boundary condition. In a case where the object 346 is arranged, the sound production device 100 verifies that there is no contradiction in the boundary condition of the virtual space acquired from the DNN, and then displays a new object 346 in the virtual space display area 310. Note that, in a case where the producer 200 does not accept the object 346 proposed to be arranged by the sound production device 100, he/she may request the sound production device 100 to change the shape, the position coordinate data and the like. In this case, the sound production device 100 changes the shape and arrangement of the object 346 so that there is no contradiction in the boundary condition of the virtual space.

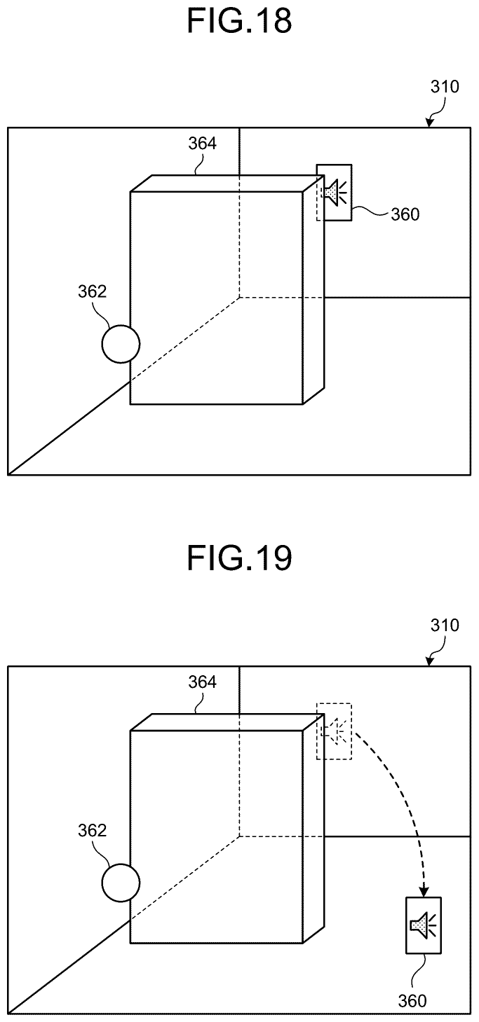

Next, an example of learning processing using the user interface 300 is described. FIG. 18 is a view (1) illustrating an example of the learning processing according to the third embodiment

As described above, the sound production device 100 may perform learning of a plurality of models 60 in accordance with the boundary condition. In this regard, the sound production device 100 may perform learning of the model 60 separately for a case where direct sound emitted from the sound source reaches the sound reception point and a case where the direct sound emitted from the sound source does not reach the sound reception point (that is, a case where the sound observed at the sound reception point is only diffracted sound or indirect sound). Note that, the direct sound refers to sound observed at the sound reception point without an obstruction between the sound source and the sound reception point and without reflection or diffraction of the sound emitted from the sound source by the wall or the ceiling even once.

In an example illustrated in FIG. 18, a sound source object 360, a sound reception point 362, and an object 364 are arranged in the virtual space display area 310. In this example, since the direct sound emitted from the sound source object 360 is interrupted by the object 364, this does not reach the sound reception point 362.

The sound production device 100 may set a situation in which the direct sound cannot be observed at the sound reception point 362 in this manner, and then perform the learning processing under such a condition. Specifically, in a case where one or more objects (the object 364 in the example of FIG. 18) are arranged at a position and in a range in which the direct sound generated by the sound source object 360 is obstructed from reaching the sound reception point 362 between the sound reception point 362 and the sound source object 360 in the virtual space, the sound production device 100 may generate, as the acoustic data, the model 60 trained using only the indirect sound from the sound source object 360 as an input. As a result, the sound production device 100 can obtain the model 60 trained under an environment not including the direct sound.

Thereafter, the sound production device 100 moves the sound source object 360 and sets a situation in which the direct sound can be observed at the sound reception point 362. Such an example is illustrated in FIG. 19. FIG. 19 is a view (2) illustrating an example of the learning processing according to the third embodiment

In the example illustrated in FIG. 19, when the sound source object 360 moves in the virtual space display area 310, the direct sound emitted from the sound source object 360 is not interrupted by the object 364 and reaches the sound reception point 362.

The sound production device 100 performs the learning processing similarly to the example of FIG. 18 even under the condition that the direct sound can be observed at the sound reception point in this manner. As a result, the sound production device 100 can obtain the model 60 trained under an environment including the direct sound.

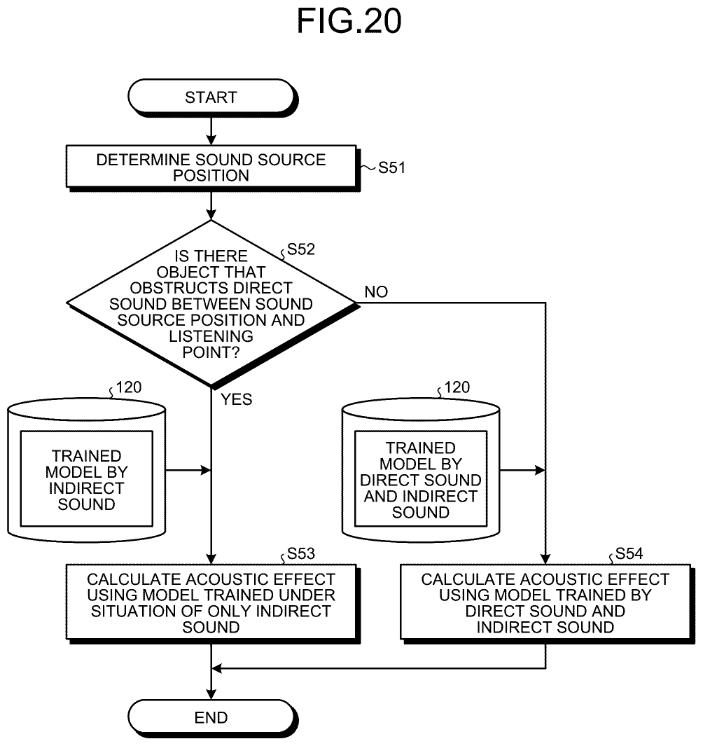

The sound production device 100 may selectively use the trained model 60 in a case of executing the arithmetic processing according to the first embodiment in a game and the like, for example. For example, in a case where one or more objects (the object 364 in the example of FIG. 18) are present at a position and in a range to obstruct the direct sound generated by the sound source object from reaching the sound reception point between the sound reception point and the sound source object in the virtual space to be analyzed, the sound production device 100 may output the acoustic signal at the sound reception point using the artificial intelligence (trained model 60) generated in consideration of only the indirect sound from the sound source object. Such processing is described with reference to FIG. 20. FIG. 20 is a flowchart illustrating the procedure of the arithmetic processing according to the third embodiment.

As illustrated in FIG. 20, the sound production device 100 determines the sound source position on the basis of the operation by the producer 200, the setting of the sound source object in the game and the like (Step S51).

Subsequently, the sound production device 100 determines whether there is an object that obstructs the direct sound between the sound source position and a listening point (for example, a location position of a game character) (Step S52). For example, the sound production device 100 determines whether a sound source (a character, an object and the like that emits sound) is included in the vision (for example, within an angle of view that can be visually recognized by a player on a game screen) of the game character located at the listening point.

In a case where there is an object that obstructs the direct sound between the sound source position and the listening point (Step S52; Yes), the sound production device 100 refers to the trained model 60 trained under the environment not including the direct sound as illustrated in the example of FIG. 18 from the storage unit 120. The sound production device 100 calculates an acoustic effect at the listening point using the model 60 trained under the situation of only the indirect sound (Step S53).

In contrast, in a case where there is no object that obstructs the direct sound between the sound source position and the listening point (Step S52; No), the sound production device 100 refers to the trained model 60 trained under the environment including the direct sound as illustrated in the example of FIG. 19 from the storage unit 120. Then, the sound production device 100 calculates the acoustic effect at the listening point using the model 60 trained with the direct sound and the indirect sound (Step S54).

In this manner, depending on the environment in which the arithmetic processing is executed, the sound production device 100 may selectively use the model 60 trained under the condition close to the environment to perform the operation regarding the sound. As a result, the sound production device 100 can reproduce the sound on the virtual space with more enhanced realistic feeling.

### 4. Fourth Embodiment

In the information processing described in each of the above-described embodiments, the example in which there is one sound production point or one sound reception point is described, but there may be a plurality of sound production points or sound reception points. For example, in a case where a plurality of sound production points is arranged, a sound production device 100 calculates an impulse response of sound reaching a sound reception point from each sound production point, and generates an acoustic signal on the basis of a calculation result. Then, the sound production device 100 reproduces the acoustic signal at the sound reception point by combining the acoustic signals generated at respective sound production points.

In such an embodiment, in a case where a position of the sound production point or the sound reception point is a physical amount that should be obtained in the second embodiment, for example, a condition that there is a plurality of sound sources may be prepared on a user interface as a check box, and in a case where a producer 200 wants to generate a plurality of sound sources, the check box may be checked. As a result, the sound production device 100 can output a plurality of sound sources and sound reception points to the virtual space according to the condition input by the producer 200.

### 5. Fifth Embodiment

In the first embodiment described above, the example in which the sound production device 100 performs the learning processing using the teacher data based on the acoustic simulation is described. Here, the sound production device 100 may perform the learning processing using not only the teacher data based on the acoustic simulation but also actual measurement data, a solution obtained by numerical calculation or the like as the teacher data. For example, the sound production device 100 uses, as the teacher data, the actual measurement data in a space reproduced in a similar shape or data obtained by numerical calculation. As a result, the sound production device 100 can improve the accuracy of learning and operation.

### 6. Sixth Embodiment

In each of the above-described embodiments, the boundary condition set for the virtual space and the object in the virtual space may change with time. For example, a sound production device 100 may perform learning processing or arithmetic processing in a virtual space including data in which at least one of a shape, position coordinate data, acoustic impedance, transmittance, and reflectance of a structure in the virtual space changes with time. As a result, the sound production device 100 can provide a sound field having a more realistic feeling with respect to a change in acoustic characteristic with respect to a state in which physical properties of the structure itself change (for example, depiction in which cloth burns or metal melts).

### 7. Seventh Embodiment

In the data processing described in each of the above-described embodiments, the sound production device 100 may handle a frequency band corresponding to duration (generally referred to as reverberation time) until energy density of sound attenuates by 60 decibels as a divided analysis target. Specifically, the sound production device 100 divides the sound to be analyzed into a reverberant sound region and a direct sound region, which is a region contributing to diffraction. Among them, the reverberant sound region is the region in which the contribution of the wave component is high as compared with the direct sound region. That is, the sound production device 100 can divide the region in which the contribution of the wave component is high and other regions, and sets the region in which the contribution of the wave component is high as an arithmetic target, thereby providing a sound field following visual information while reducing an overall operation amount.

The sound production device 100 may employ a sound ray tracking method, which is a geometric method not including wave sound, for the reverberant sound region described above. Note that, in order to provide sound without strange feeling in a band that is a boundary between the reverberant sound region and the direct sound region, the sound production device 100 may calculate a buffer of about 30% before and after the reverberation time by both methods of the reverberant sound region and the direct sound region, and calculate a continuous value by adding physical amounts such as sound pressure. For example, the sound production device 100 can provide natural sound at high speed by calculating the direct sound as a wave and reverberant sound as a sound ray, and combining them in, for example, a region within the reverberation time as a sound simulator.

### 8. Eighth Embodiment

In the second embodiment, the sound production device 100 may additionally acquire an input of shape data of an object and position coordinate data of a sound source and a sound reception point in addition to a condition (impulse response) input by the producer 200. That is, the sound production device 100 can output not only the acoustic impedance but also shape data and the like of an additional object by an inverse operation.

In the above-described processing, the sound production device 100 may perform processing of reducing an error by adding a numerical error influence in the inverse operation to the components. For example, by defining the error value as an unknown object, the sound production device 100 can output a new object that satisfies the inverse operation within a range of the numerical error.

### 9. Other Embodiment

The processing according to each embodiment described above may be performed in various different modes other than each embodiment described above.

Out of each processing described in the above-described embodiments, an entire or a part of the processing described as being performed automatically can be performed manually, or an entire or a part of the processing described as being performed manually can be performed automatically by a known method. The procedure, specific name, and data including various data and parameters described in the document and illustrated in the drawings can be optionally changed unless otherwise specified. For example, the various data illustrated in each drawing are not limited to the illustrated data.

Each component of each device illustrated in the drawings is functionally conceptual, and is not necessarily physically configured as illustrated in the drawings. That is, a specific form of distribution and integration of each device is not limited to the illustrated form, and an entire or a part thereof can be functionally or physically distributed and integrated in any unit according to various loads, usage conditions and the like.

The above-described embodiments and variations can be appropriately combined within a range in which the processing contents do not contradict each other.

The effects described in the present specification are merely examples and are not limited, and there may be other effects.

### 10. Effect of Acoustic Signal Control Method and Learning Model Generation Method According to Present Disclosure

As described above, an acoustic signal control method according to the present disclosure includes selecting a sound source object to be arranged on a three-dimensional virtual space, arranging the selected sound source object at a predetermined position on the three-dimensional virtual space in which one or more three-dimensional objects are arranged, inputting position data and acoustic data regarding the arranged sound source object, region data in the three-dimensional virtual space, structure data of the three-dimensional object, and position data of each object and a sound reception point at a predetermined time to first artificial intelligence (in the embodiment, a model 60), and outputting, on the basis of an impulse response at the sound reception point generated from output data, an acoustic signal at the sound reception point.

In this manner, the acoustic signal control method according to the present disclosure generates the acoustic signal at the sound reception point by using the artificial intelligence having, as the input, the structure of the virtual space, coordinates of the object arranged in the virtual space, the structure data including acoustic impedance and the like. As a result, the acoustic signal control method does not require enormous calculation of solving a wave equation in an entire region, and can reproduce an acoustic space with realistic feeling and implement high-speed arithmetic processing.

At that time, the acoustic signal control method outputs the acoustic signal on the basis of the sound pressure at the sound reception point calculated from the impulse response at the sound reception point.

In this manner, since the acoustic signal control method can obtain the sound pressure from the impulse response, it is possible to implement the output of the acoustic signal with high reproducibility including the sound pressure at the sound reception point.

The acoustic signal control method includes acquiring an input of a request regarding arrangement of the three-dimensional object from a user (in the embodiment, a producer 200) by an input unit 131, and determining the structure data on the basis of specification from the user regarding at least any one of a material, transmittance, reflectance, and position data of the three-dimensional object included in the input of the request.

In this manner, the acoustic signal control method acquires the input of the request such as arrangement of the object in the virtual space from the user via the user interface and the like, and reflects the acquired data in control of the generated acoustic signal. As a result, the user can quickly and easily perform the acoustic design of the content.

The acoustic signal control method outputs, in a case of acquiring the input of the request regarding the arrangement of the three-dimensional object from the user, the acoustic signal at the sound reception point recalculated on the basis of the structure data of the three-dimensional object after being changed by the request.

In this manner, the acoustic signal control method may output the sound before and after the change for a sound environment of the virtual space that changes with the user operation. As a result, the user can immediately confirm the changed sound, thereby improving workability.

The acoustic signal control method outputs the acoustic signal at the sound reception point using the first artificial intelligence generated in consideration of only indirect sound from the sound source object in a case where one or more three-dimensional objects are present at a position and in a range to obstruct direct sound generated by the sound source object from reaching the sound reception point between the sound reception point and the sound source object in the three-dimensional virtual space.

In this manner, the acoustic signal control method may output the acoustic signal using the artificial intelligence trained according to the situation assumed in the virtual space. According to such acoustic signal control method, since the acoustic signal can be output using the artificial intelligence trained further in accordance with the situation, reproducibility of the acoustic signal can be enhanced, and the realistic feeling of the sound can be improved.

The acoustic signal control method further includes acquiring an input of a request regarding an output of an acoustic signal desired by a user, and inputting the output of the acoustic signal desired by the user to first artificial intelligence (in the embodiment, a model 80) in a case of acquiring the input of the request, and outputting, from data output by an inverse operation, at least any one of data regarding the three-dimensional virtual space or the three-dimensional object required for implementing the output of the acoustic signal desired by the user or data regarding the sound source object.

In this manner, the acoustic signal control method may execute an operation opposite to the operation by the first artificial intelligence of deriving data (acoustic impedance and the like) related to the virtual space on the basis of a request such as an impulse response desired by the user. According to such acoustic signal control method, the user can implement a sound environment ideal for the user himself/herself without manually setting an object to be newly arranged in the virtual space.

The acoustic signal control method outputs at least any one of a change in boundary condition of a space to be analyzed, a change in structure data of the three-dimensional object already arranged, or the structure data of the three-dimensional object that should be newly arranged in the three-dimensional virtual space as the data regarding the three-dimensional virtual space or the three-dimensional object.

In this manner, the acoustic signal control method can make a proposal to the user, such as outputting an object for implementing the sound environment ideal for the user.

The acoustic signal control method outputs the position data of the sound source object in which the output of the acoustic signal desired by the user is implemented at the sound reception point as the data regarding the sound source object.

In this manner, the acoustic signal control method can automatically arrange the object for implementing the sound environment ideal for the user without bothering the user.

A learning model generation method according to the present disclosure includes selecting a sound source object to be arranged on a three-dimensional virtual space, arranging the selected sound source object at a predetermined position on the three-dimensional virtual space in which one or more three-dimensional objects are arranged, and generating first artificial intelligence having acoustic data regarding the arranged sound source object, region data in the three-dimensional virtual space, structure data of the three-dimensional object, and position data of each object and a sound reception point at a predetermined time as an input and having a transfer function indicating a relationship when sound emitted from the sound source object is observed at the sound reception point as an output by learning based on predetermined teacher data.

In this manner, the learning model generation method enables a high-speed operation for outputting an acoustic signal without unnaturalness even in the virtual space by generating artificial intelligence (trained model) that learns a relationship between various data set in the virtual space.

The learning model generation method generates the first artificial intelligence by performing learning of the first artificial intelligence so as to minimize a sum of an error between the transfer function output from the first artificial intelligence and a dominant equation corresponding to the input, an error between the transfer function output from the first artificial intelligence and a transfer function output by inverting position data of arrangement of the sound source object and position data of the sound reception point, and an error between the predetermined teacher data and the transfer function output from the first artificial intelligence.

In this manner, the learning model generation method can generate high-performance artificial intelligence capable of deriving an arithmetic result having a small difference from an acoustic simulation result that requires enormous calculation by advancing learning on the basis of a plurality of error evaluations.

The learning model generation method generates the first artificial intelligence trained using only indirect sound from the sound source object as an input as acoustic data in a case where one or more three-dimensional objects are arranged at a position and in a range to obstruct direct sound generated by the sound source object from reaching the sound reception point between the sound reception point and the sound source object in the three-dimensional virtual space.

In this manner, the learning model generation method can generate the artificial intelligence (trained model) different between a case of including the direct sound and a case of not including the direct sound, thereby reproducing the acoustic signal more suitable for the environment assumed in the virtual space when calculating.

### 11. Hardware Configuration

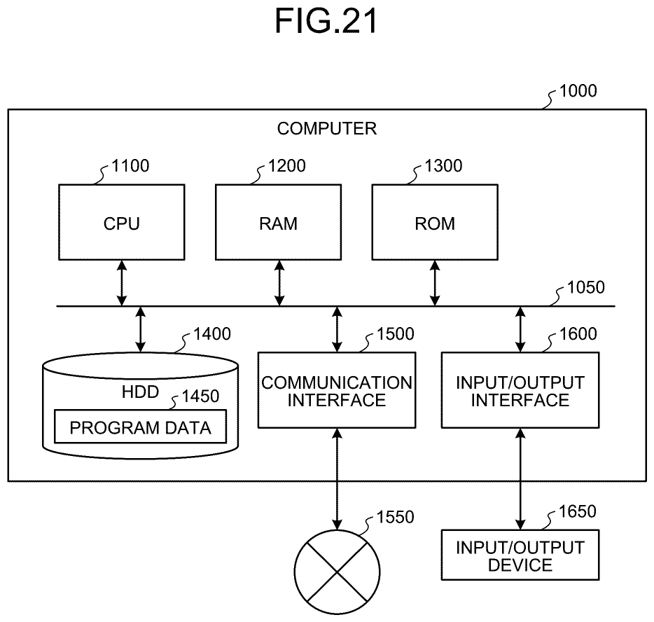

The information device such as the sound production device 100 according to each embodiment described above is implemented by a computer 1000 having a configuration as illustrated in FIG. 21, for example. Hereinafter, it is described with the sound production device 100 according to the first embodiment as an example. FIG. 21 is a hardware configuration diagram illustrating an example of the computer 1000 that implements functions of the sound production device 100. The computer 1000 includes a CPU 1100, a RAM 1200, a read only memory (ROM) 1300, a hard disk drive (HDD) 1400, a communication interface 1500, and an input/output interface 1600. Each unit of the computer 1000 is connected by a bus 1050.

The CPU 1100 operates on the basis of a program stored in the ROM 1300 or the HDD 1400, and controls each unit. For example, the CPU 1100 develops a program stored in the ROM 1300 or the HDD 1400 in the RAM 1200, and executes processing corresponding to various programs.

The ROM 1300 stores a boot program such as a basic input output system (BIOS) executed by the CPU 1100 when the computer 1000 is activated, a program depending on hardware of the computer 1000 and the like.

The HDD 1400 is a computer-readable recording medium that non-transiently records a program executed by the CPU 1100, data used by the program and the like. Specifically, the HDD 1400 is a recording medium that records an information processing program according to the present disclosure as an example of program data 1450.

The communication interface 1500 is an interface for the computer 1000 to connect to an external network 1550 (for example, the Internet). For example, the CPU 1100 receives data from another device or transmits data generated by the CPU 1100 to another device via the communication interface 1500.

The input/output interface 1600 is an interface for connecting an input/output device 1650 and the computer 1000. For example, the CPU 1100 receives data from an input device such as a keyboard and a mouse via the input/output interface 1600. The CPU 1100 transmits data to an output device such as a display, a speaker, or a printer via the input/output interface 1600. The input/output interface 1600 may function as a medium interface that reads a program and the like recorded in a predetermined recording medium (medium). The medium is, for example, an optical recording medium such as a digital versatile disc (DVD) or a phase change rewritable disk (PD), a magneto-optical recording medium such as a magneto-optical disk (MO), a tape medium, a magnetic recording medium, a semiconductor memory or the like.

For example, in a case where the computer 1000 functions as the sound production device 100 according to the first embodiment, the CPU 1100 of the computer 1000 implements the functions of the control unit 130 and the like by executing the information processing program loaded on the RAM 1200. The HDD 1400 stores the acoustic signal control program according to the present disclosure and data in the storage unit 120. Note that, the CPU 1100 reads the program data 1450 from the HDD 1400 to execute, but as another example, these programs may be acquired from another device via the external network 1550.

Note that, the present technology can also have the following configurations.

(1) An acoustic signal control method comprising:
selecting a sound source object to be arranged on a three-dimensional virtual space;
arranging the selected sound source object at a predetermined position on the three-dimensional virtual space in which one or more three-dimensional objects are arranged;
inputting position data and acoustic data regarding the arranged sound source object, region data in the three-dimensional virtual space, structure data of the three-dimensional object, and position data of each object and a sound reception point at a predetermined time to first artificial intelligence, and outputting, on the basis of an impulse response at the sound reception point generated from output data, an acoustic signal at the sound reception point
by a computer.
   (2) The acoustic signal control method according to (1), comprising:
outputting the acoustic signal on the basis of a sound pressure at the sound reception point calculated from the impulse response at the sound reception point.
   (3) The acoustic signal control method according to (1) or (2), wherein
the region data in the three-dimensional virtual space is a boundary condition of a space to be analyzed, and coordinate information of a boundary forming the three-dimensional virtual space.
   (4) The acoustic signal control method according to any one of (1) to (3), wherein
structure data of the three-dimensional object is acoustic impedance set in the three-dimensional object, and coordinate information of a point group forming the three-dimensional object.
   (5) The acoustic signal control method according to (4), further comprising:
acquiring an input of a request regarding arrangement of the three-dimensional object from a user; and
determining the structure data on the basis of specification from the user regarding at least any one of a material, transmittance, reflectance, and position data of the three-dimensional object included in the input of the request.
   (6) The acoustic signal control method according to (5), comprising:
outputting, in a case of acquiring the input of the request regarding the arrangement of the three-dimensional object from the user, the acoustic signal at the sound reception point recalculated on the basis of the structure data of the three-dimensional object after being changed by the request.
   (7) The acoustic signal control method according to any one of (1) to (6), comprising:
outputting the acoustic signal at the sound reception point using the first artificial intelligence generated in consideration of only indirect sound from the sound source object in a case where one or more of the three-dimensional objects are present at a position and in a range to obstruct direct sound generated by the sound source object from reaching the sound reception point between the sound reception point and the sound source object in the three-dimensional virtual space.
   (8) The acoustic signal control method according to any one of (1) to (7), wherein
the first artificial intelligence is a machine learning algorithm.
   (9) The acoustic signal control method according to any one of (1) to (8), wherein
the first artificial intelligence is a deep neural network.
   (10) The acoustic signal control method according to (9), wherein
an output of the deep neural network is an output of a Green's function.
   (11) The acoustic signal control method according to any one of (1) to (10), further comprising:
acquiring an input of a request regarding an output of an acoustic signal desired by a user; and
inputting the output of the acoustic signal desired by the user to first artificial intelligence in a case of acquiring the input of the request, and outputting, from data output by an inverse operation, at least any one of information regarding the three-dimensional virtual space or the three-dimensional object required for implementing the output of the acoustic signal desired by the user or information regarding the sound source object.
   (12) The acoustic signal control method according to (11), comprising:
outputting at least any one of a change in boundary condition of a space to be analyzed, a change in structure data of the three-dimensional object already arranged, or the structure data of the three-dimensional object that should be newly arranged in the three-dimensional virtual space as the information regarding the three-dimensional virtual space or the three-dimensional object.
   (13) The acoustic signal control method according to (11) or (12), comprising:
outputting the position data of the sound source object in which the output of the acoustic signal desired by the user is implemented at the sound reception point as the information regarding the sound source object.
   (14) A learning model generation method comprising:
selecting a sound source object to be arranged on a three-dimensional virtual space;
arranging the selected sound source object at a predetermined position on the three-dimensional virtual space in which one or more three-dimensional objects are arranged; and
generating first artificial intelligence having acoustic data regarding the arranged sound source object, region data in the three-dimensional virtual space, structure data of the three-dimensional object, and position data of each object and a sound reception point at a predetermined time as an input and having a transfer function indicating a relationship when sound emitted from the sound source object is observed at the sound reception point as an output by learning based on predetermined teacher data by a computer.
   (15) The learning model generation method according to (14), wherein
the predetermined teacher data is data acquired on the basis of acoustic simulation in the three-dimensional virtual space or data observed in a real space.
   (16) The learning model generation method according to (15), comprising
generating the first artificial intelligence by performing learning of the first artificial intelligence so as to minimize a sum of an error between the transfer function output from the first artificial intelligence and a dominant equation corresponding to the input, an error between the transfer function output from the first artificial intelligence and a transfer function output by inverting position data of arrangement of the sound source object and position data of the sound reception point, and an error between the predetermined teacher data and the transfer function output from the first artificial intelligence.
   (17) The learning model generation method according to any one of (14) to (16), wherein
the first artificial intelligence is a machine learning algorithm.
   (18) The learning model generation method according to any one of (14) to (17), wherein
the first artificial intelligence is a deep neural network, and
an output of the deep neural network is an output of a Green's function.
   (19) The learning model generation method according to any one of (14) to (18), comprising:
generating the first artificial intelligence trained using only indirect sound from the sound source object as an input as the acoustic data in a case where the one or more three-dimensional objects are arranged at a position and in a range to obstruct direct sound generated by the sound source object from reaching the sound reception point between the sound reception point and the sound source object in the three-dimensional virtual space.
   (20) An acoustic signal control program product, comprising an acoustic signal control program that causes
a computer to
serve as an acoustic signal control device that executes an acoustic signal control method including:
selecting a sound source object to be arranged on a three-dimensional virtual space;
arranging the selected sound source object at a predetermined position on the three-dimensional virtual space in which one or more three-dimensional objects are arranged; and
inputting position data and acoustic data regarding the arranged sound source object, region data in the three-dimensional virtual space, structure data of the three-dimensional object, and position data of each object and a sound reception point at a predetermined time to first artificial intelligence, and outputting, on the basis of an impulse response at the sound reception point generated from output data, an acoustic signal at the sound reception point.

### REFERENCE SIGNS LIST

10 VIRTUAL SPACE
100 SOUND PRODUCTION DEVICE
110 COMMUNICATION UNIT
120 STORAGE UNIT
130 CONTROL UNIT
131 INPUT UNIT
132 LEARNING UNIT
133 ARITHMETIC UNIT
134 DISPLAY CONTROL UNIT
135 OUTPUT CONTROL UNIT
140 OUTPUT UNIT
150 DISPLAY
160 SPEAKER
200 PRODUCER
300 USER INTERFACE

1. An acoustic signal control method comprising:
selecting a sound source object to be arranged on a three-dimensional virtual space;
arranging the selected sound source object at a predetermined position on the three-dimensional virtual space in which one or more three-dimensional objects are arranged;
inputting position data and acoustic data regarding the arranged sound source object, region data in the three-dimensional virtual space, structure data of the three-dimensional object, and position data of each object and a sound reception point at a predetermined time to first artificial intelligence, and outputting, on the basis of an impulse response at the sound reception point generated from output data, an acoustic signal at the sound reception point
by a computer.

2. The acoustic signal control method according to claim 1, comprising:
outputting the acoustic signal on the basis of a sound pressure at the sound reception point calculated from the impulse response at the sound reception point.

3. The acoustic signal control method according to claim 1, wherein
the region data in the three-dimensional virtual space is a boundary condition of a space to be analyzed, and coordinate information of a boundary forming the three-dimensional virtual space.

4. The acoustic signal control method according to claim 1, wherein
structure data of the three-dimensional object is acoustic impedance set in the three-dimensional object, and coordinate information of a point group forming the three-dimensional object.

5. The acoustic signal control method according to claim 4, further comprising:
acquiring an input of a request regarding arrangement of the three-dimensional object from a user; and
determining the structure data on the basis of specification from the user regarding at least any one of a material, transmittance, reflectance, and position data of the three-dimensional object included in the input of the request.

6. The acoustic signal control method according to claim 5, comprising:
outputting, in a case of acquiring the input of the request regarding the arrangement of the three-dimensional object from the user, the acoustic signal at the sound reception point recalculated on the basis of the structure data of the three-dimensional object after being changed by the request.

7. The acoustic signal control method according to claim 1, comprising:
outputting the acoustic signal at the sound reception point using the first artificial intelligence generated in consideration of only indirect sound from the sound source object in a case where one or more of the three-dimensional objects are present at a position and in a range to obstruct direct sound generated by the sound source object from reaching the sound reception point between the sound reception point and the sound source object in the three-dimensional virtual space.

8. The acoustic signal control method according to claim 1, wherein
the first artificial intelligence is a machine learning algorithm.

9. The acoustic signal control method according to claim 1, wherein
the first artificial intelligence is a deep neural network.

10. The acoustic signal control method according to claim 9, wherein
an output of the deep neural network is an output of a Green's function.

11. The acoustic signal control method according to claim 1, further comprising:
acquiring an input of a request regarding an output of an acoustic signal desired by a user; and
inputting the output of the acoustic signal desired by the user to first artificial intelligence in a case of acquiring the input of the request, and outputting, from data output by an inverse operation, at least any one of information regarding the three-dimensional virtual space or the three-dimensional object required for implementing the output of the acoustic signal desired by the user or information regarding the sound source object.

12. The acoustic signal control method according to claim 11, comprising:
outputting at least any one of a change in boundary condition of a space to be analyzed, a change in structure data of the three-dimensional object already arranged, or the structure data of the three-dimensional object that should be newly arranged in the three-dimensional virtual space as the information regarding the three-dimensional virtual space or the three-dimensional object.

13. The acoustic signal control method according to claim 11, comprising:
outputting the position data of the sound source object in which the output of the acoustic signal desired by the user is implemented at the sound reception point as the information regarding the sound source object.

14. A learning model generation method comprising:
selecting a sound source object to be arranged on a three-dimensional virtual space;
arranging the selected sound source object at a predetermined position on the three-dimensional virtual space in which one or more three-dimensional objects are arranged; and
generating first artificial intelligence having acoustic data regarding the arranged sound source object, region data in the three-dimensional virtual space, structure data of the three-dimensional object, and position data of each object and a sound reception point at a predetermined time as an input and having a transfer function indicating a relationship when sound emitted from the sound source object is observed at the sound reception point as an output by learning based on predetermined teacher data
by a computer.

15. The learning model generation method according to claim 14, wherein
the predetermined teacher data is data acquired on the basis of acoustic simulation in the three-dimensional virtual space or data observed in a real space.

16. The learning model generation method according to claim 15, comprising
generating the first artificial intelligence by performing learning of the first artificial intelligence so as to minimize a sum of an error between the transfer function output from the first artificial intelligence and a dominant equation corresponding to the input, an error between the transfer function output from the first artificial intelligence and a transfer function output by inverting position data of arrangement of the sound source object and position data of the sound reception point, and an error between the predetermined teacher data and the transfer function output from the first artificial intelligence.

17. The learning model generation method according to claim 16, wherein
the first artificial intelligence is a machine learning algorithm.

18. The learning model generation method according to claim 17, wherein
the first artificial intelligence is a deep neural network, and
an output of the deep neural network is an output of a Green's function.

19. The learning model generation method according to claim 14, comprising:
generating the first artificial intelligence trained using only indirect sound from the sound source object as an input as the acoustic data in a case where the one or more three-dimensional objects are arranged at a position and in a range to obstruct direct sound generated by the sound source object from reaching the sound reception point between the sound reception point and the sound source object in the three-dimensional virtual space.

20. An acoustic signal control program product, comprising an acoustic signal control program that causes
a computer to
serve as an acoustic signal control device that executes an acoustic signal control method including:
selecting a sound source object to be arranged on a three-dimensional virtual space;
arranging the selected sound source object at a predetermined position on the three-dimensional virtual space in which one or more three-dimensional objects are arranged; and
inputting position data and acoustic data regarding the arranged sound source object, region data in the three-dimensional virtual space, structure data of the three-dimensional object, and position data of each object and a sound reception point at a predetermined time to first artificial intelligence, and outputting, on the basis of an impulse response at the sound reception point generated from output data, an acoustic signal at the sound reception point.
